(19) United States
(12) Patent Application Publication
(10) Pub. No.: US 2021/0078698 A1
(43) Pub. Date: Mar. 18, 2021

(54) PROPELLER ASSEMBLY, POWER ASSEMBLY, AND AIRCRAFT

(71) Applicant: SZ DJI TECHNOLOGY CO., LTD., Shenzhen (CN)

(72) Inventors: Yihan LIU, Shenzhen (CN); Peng CHEN, Shenzhen (CN); Tao DENG, Shenzhen (CN)

(21) Appl. No.: 17/105,915

(22) Filed: Nov. 27, 2020

Related U.S. Application Data
(63) Continuation of application No. PCT/CN2018/088630, filed on May 28, 2018.

(51) Int. Cl. B64C 27/46; B64C 27/473; B64D 27/02; F01D 5/02; F01D 5/30

(52) U.S. Cl. CPC B64C 27/463; B64C 27/473; F01D 5/30; F01D 5/02; B64D 27/02

(57) ABSTRACT

A propeller assembly includes a first and a second propellers. The first propeller includes a first propeller blade including a first propeller root, a first propeller tip opposite to the first propeller root, a first propeller pressure surface, and a first propeller suction surface opposite to the first propeller pressure surface. The second propeller includes a second propeller blade including a second propeller root, a second propeller tip opposite to the second propeller root, a second propeller pressure surface, and a second propeller suction surface opposite to the second propeller pressure surface. The first propeller tip is configured to extend obliquely along a span direction of the first propeller blade toward a side where the first propeller suction surface is located. The second propeller tip is configured to extend obliquely along a span direction of the second propeller blade toward a side where the second propeller pressure surface is located.

### CROSS-REFERENCE TO RELATED APPLICATION

This application is a continuation of International Application No. PCT/CN2018/088630, filed on May 28, 2018, the entire content of which is incorporated herein by reference.

A portion of the disclosure of this patent document (e.g., the claims, description, drawings, and abstract) contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the technical field of aircraft and, more particularly, to a propeller assembly, a power assembly, and an aircraft.

### BACKGROUND

A propeller is one of the key components of an aircraft and used to convert a rotation of a shaft of a motor or engine into thrust or lift.

In conventional technologies, during a rotation of the propeller, a turbulence of each portion of a propeller blade and a downwash flow impacting on a housing structure of the aircraft generate relatively large noise. The noise is often superimposed with motor noise and structural vibration noise, and noise in certain frequency bands is amplified, resulting in higher overall noise of the aircraft and poor user experience.

### SUMMARY

In accordance with the disclosure, there is provided a propeller assembly including a first and a second propellers. The first propeller includes a first propeller blade including a first propeller root, a first propeller tip opposite to the first propeller root, a first propeller pressure surface, and a first propeller suction surface opposite to the first propeller pressure surface. The second propeller includes a second propeller blade including a second propeller root, a second propeller tip opposite to the second propeller root, a second propeller pressure surface, and a second propeller suction surface opposite to the second propeller pressure surface. The first propeller tip is configured to extend obliquely along a span direction of the first propeller blade toward a side where the first propeller suction surface is located. The second propeller tip is configured to extend obliquely along a span direction of the second propeller blade toward a side where the second propeller pressure surface is located.

Also in accordance with the disclosure, there is provided a power assembly including a first and a second driving devices, and a propeller assembly. The propeller assembly includes a first and a second propellers. The first propeller includes a first propeller blade including a first propeller root, a first propeller tip opposite to the first propeller root, a first propeller pressure surface, and a first propeller suction surface opposite to the first propeller pressure surface. The second propeller includes a second propeller blade including a second propeller root, a second propeller tip opposite to the second propeller root, a second propeller pressure surface, and a second propeller suction surface opposite to the second propeller pressure surface. The first propeller tip is configured to extend obliquely along a span direction of the first propeller blade toward a side where the first propeller suction surface is located. The second propeller tip is configured to extend obliquely along a span direction of the second propeller blade toward a side where the second propeller pressure surface is located.

Also in accordance with the disclosure, there is provided an aircraft including a body and a power assembly connected to the body. The power assembly includes a first and a second driving devices, and a propeller assembly. The propeller assembly includes a first and a second propellers. The first propeller includes a first propeller blade including a first propeller root, a first propeller tip opposite to the first propeller root, a first propeller pressure surface, and a first propeller suction surface opposite to the first propeller pressure surface. The second propeller includes a second propeller blade including a second propeller root, a second propeller tip opposite to the second propeller root, a second propeller pressure surface, and a second propeller suction surface opposite to the second propeller pressure surface. The first propeller tip is configured to extend obliquely along a span direction of the first propeller blade toward a side where the first propeller suction surface is located. The second propeller tip is configured to extend obliquely along a span direction of the second propeller blade toward a side where the second propeller pressure surface is located.

### BRIEF DESCRIPTION OF THE DRAWINGS

In order to provide a clearer illustration of technical solutions of disclosed embodiments, the drawings used in the description of the disclosed embodiments are briefly described below.

FIG. 1 is a schematic plan view of a propeller assembly consistent with embodiments of the disclosure.

FIG. 2 is a perspective view of a first propeller of the propeller assembly in FIG. 1.

FIG. 3 is another perspective view of the first propeller of the propeller assembly in FIG. 1.

FIGS. 4 to 7 are schematic plan views of the first propeller of the propeller assembly in FIG. 1.

FIG. 8 is a parameter diagram of a first propeller backward-sweeping portion of the first propeller in FIG. 2 extending obliquely from a first propeller leading edge of the first propeller to a first propeller trailing edge.

FIG. 9 is a parameter diagram of the first propeller leading edge of the first propeller in FIG. 2 extending obliquely along a span direction of a first propeller blade toward a side where a first propeller suction surface of the first propeller is located.

FIG. 10 is a cross-sectional view of the first propeller along A-A line in FIG. 7 at a distance of 15 mm from a center of a first propeller hub.

FIG. 11 is a cross-sectional view of the first propeller along B-B line in FIG. 7 at a distance of 20 mm from a center of a first propeller hub.

FIG. 12 is a cross-sectional view of the first propeller along C-C line in FIG. 7 at a distance of 25 mm from a center of a first propeller hub.

FIG. 13 is a cross-sectional view of the first propeller along D-D line in FIG. 7 at a distance of 30 mm from a center of a first propeller hub.

FIG. 14 is a cross-sectional view of the first propeller along E-E line in FIG. 7 at a distance of 35 mm from a center of a first propeller hub.

FIG. 15 is a cross-sectional view of the first propeller along F-F line in FIG. 7 at a distance of 40 mm from a center of a first propeller hub.

FIG. 16 is a cross-sectional view of the first propeller along G-G line in FIG. 7 at a distance of 30 mm from a center of a first propeller hub.

FIG. 17 is a cross-sectional view of the first propeller along H-H line in FIG. 7 at a distance of 50 mm from a center of a first propeller hub.

FIG. 18 is a cross-sectional view of the first propeller along I-I line in FIG. 7 at a distance of 55 mm from a center of a first propeller hub.

FIG. 19 is a cross-sectional view of the first propeller along J-J line in FIG. 7 at a distance of 60 mm from a center of a first propeller hub.

FIG. 20 is a cross-sectional view of the first propeller along K-K line in FIG. 7 at a distance of 66.5 mm from a center of a first propeller hub.

FIG. 21 is a perspective view of a second propeller of the propeller assembly in FIG. 1.

FIG. 22 is another perspective view of the second propeller of the propeller assembly in FIG. 1.

FIGS. 23 to 26 are schematic plan views of the second propeller of the propeller assembly in FIG. 1.

FIG. 27 is a parameter diagram of a second propeller backward-sweeping portion of the second propeller in FIG. 21 extending obliquely from a second propeller leading edge of the second propeller to a second propeller trailing edge of the second propeller.

FIG. 28 is a parameter diagram of a second propeller leading edge of the second propeller in FIG. 21 extending obliquely along a span direction of a second propeller blade toward a side where a second propeller pressure surface of the second propeller is located.

FIG. 29 is a schematic frequency response curve of a first propeller or a second propeller of a propeller assembly consistent with the disclosure and an existing propeller under same acoustic performance test conditions of hovering.

FIG. 30 is a schematic plan view of an aircraft consistent with embodiments of the disclosure.

### DETAILED DESCRIPTION OF THE EMBODIMENTS

Example embodiments will be described with reference to the accompanying drawings, in which the same numbers refer to the same or similar elements unless otherwise specified. The described embodiments are merely examples of devices consistent with some aspects of the present disclosure.

Herein, the terms “first,” “second,” “third,” and the like, are merely for illustrating various information, but not intended to limit the information. The terms are merely used to distinguish the same type of information from each other. For example, without departing from the scope of the present disclosure, first information may also be referred to as second information, and similarly, the second information may also be referred to as the first information. As used herein, the word “if” can be interpreted as “when,” “while,” or “in response to.”

The present disclosure provides a propeller assembly including a forward propeller and a reverse propeller. The forward propeller can refer to a propeller rotating counterclockwise (CCW) to generate lift when viewed from a tail of a motor (example of a driving device) to a head of the motor. The reverse propeller can refer to a propeller rotating clockwise (CW) to generate lift when viewed from the tail of the motor to the head of the motor. The azimuth terms, for example, “up,” “down,” and the like, can be defined according to normal operation attitudes of the propeller assembly and an aircraft, after the propeller assembly is mounted at the aircraft.

Hereinafter, the propeller assembly, a power assembly, and the aircraft consistent with the present disclosure will be described with reference to the accompanying drawings. Unless conflicting, the described embodiments and features of the embodiments can be combined with each other.

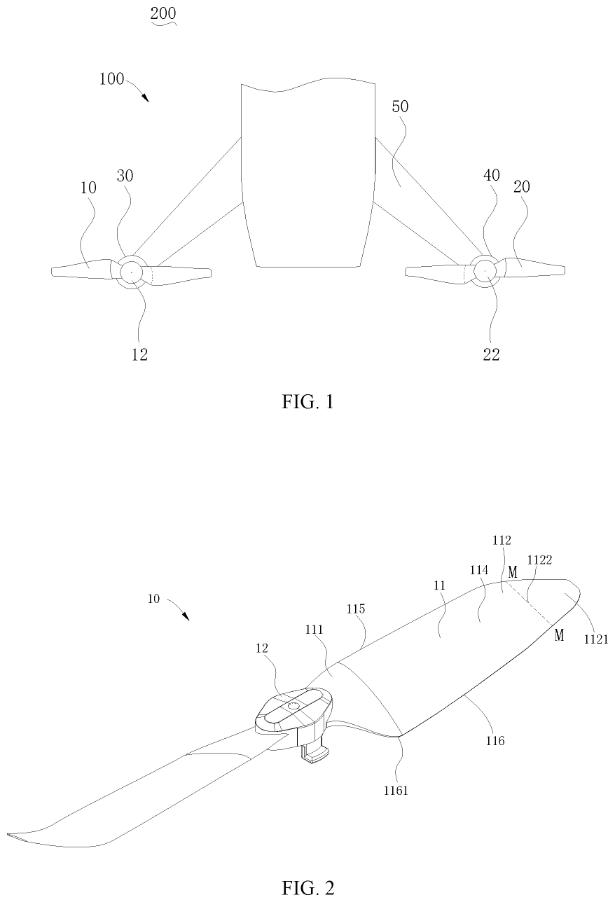

FIG. 1 is a schematic plan view of an example propeller assembly 100 consistent with the disclosure. As shown in FIG. 1, the propeller assembly 100 include a first propeller 10 and a second propeller 20.

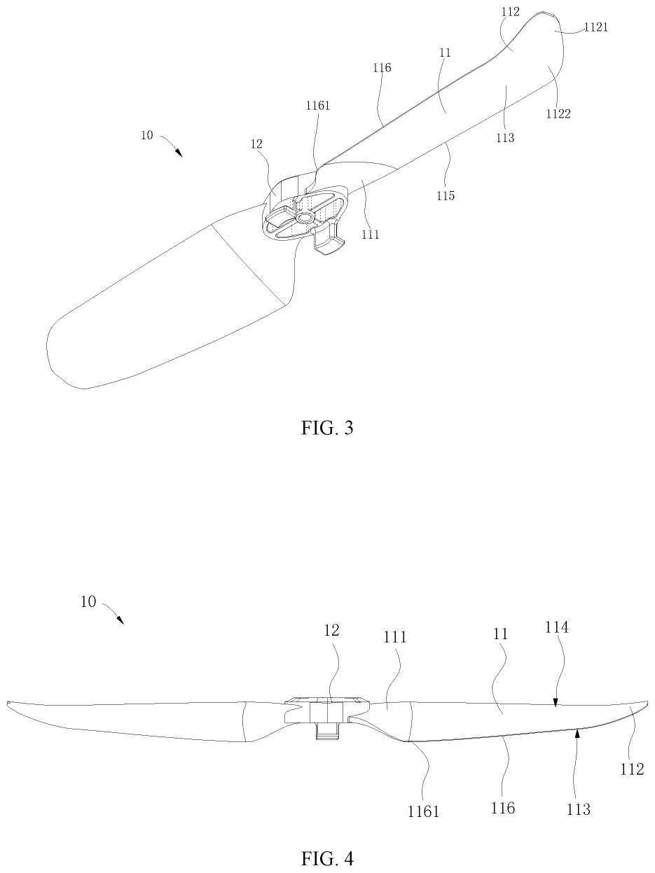

FIGS. 2 and 3 are perspective views of the first propeller 10 of the propeller assembly 100 consistent with the disclosure. As shown in FIGS. 2 and 3, the first propeller 10 includes a first propeller blade 11. The first propeller blade 11 includes a first propeller root 111, a first propeller tip 112 opposite to the first propeller root 111, and a first propeller pressure surface 113 and a first propeller suction surface 114 opposite to each other. The first propeller tip 112 can be configured to extend obliquely along a span direction of the first propeller blade 11 toward a side where the first propeller suction surface 114 is located.

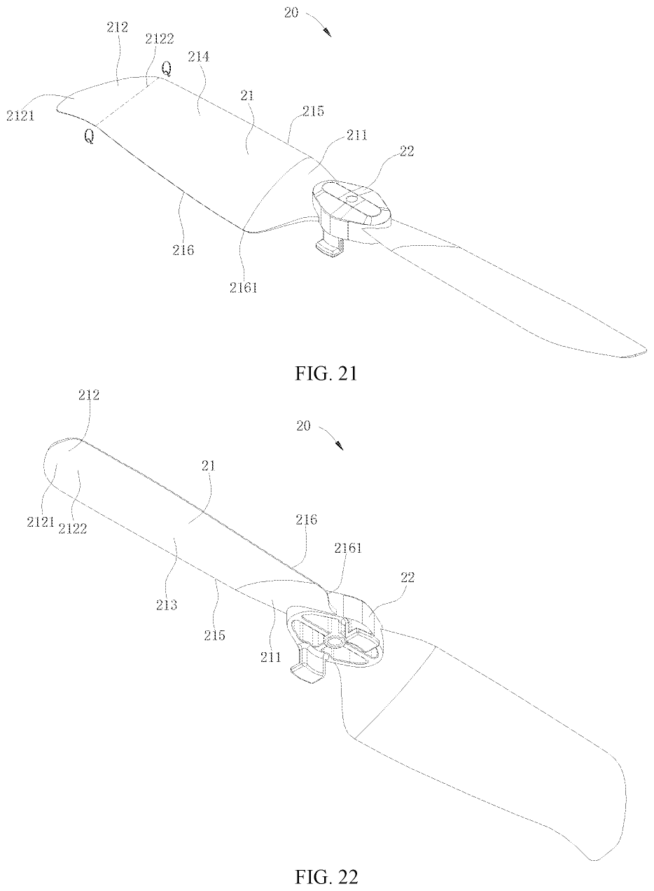

FIGS. 21 and 22 are perspective views of the second propeller 20 of the propeller assembly 100 consistent with the disclosure. As shown in FIGS. 21 and 22, the second propeller 20 includes a second propeller blade 21. The second propeller blade 21 includes a second propeller root 211, a second propeller tip 212 opposite to the second propeller root 111, and a second propeller pressure surface 213 and a second propeller suction surface 214 opposite to each other. The second propeller tip 212 can be configured to extend obliquely along a span direction of the second propeller blade 21 toward a side where the second propeller pressure surface 213 is located.

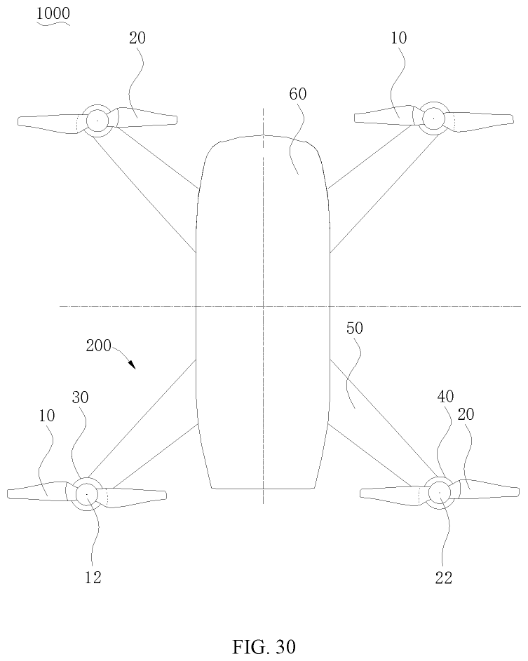

Consistent with the disclosure, the first propeller tip 112 of the propeller assembly 100 can be configured to extend obliquely along the span direction of the first propeller blade 11 toward the side where the first propeller suction surface 114 is located. The second propeller tip 212 can be configured to extend obliquely along the span direction of the second propeller blade 21 toward the side where the second propeller suction surface 214 is located. The propeller assembly 100 using the first propeller blade 11 and the second propeller blade 21 can reduce air resistance and improve tension and efficiency. A flight distance of an aircraft 1000 (shown in FIG. 30) can be increased, a flight performance of the aircraft 1000 can be improved, and a noise generated by the first propeller blade 11 and the second propeller blade 21 during operation can be reduced, thereby causing the aircraft 1000 to be quieter when hovering and improving a user experience.

Referring again to FIG. 1, in some embodiments, the first propeller 10 and the second propeller 20 can be mirror-symmetrical with respect to each other.

FIG. 3 is another perspective view of the first propeller 10 of the propeller assembly 100 in FIG. 1. FIGS. 4 to 7 are schematic plan views of the first propeller 10 of the propeller assembly 100 in FIG. 1. As shown in FIGS. 2 to 6, the first propeller blade 11 includes the first propeller root 111, the first propeller tip 112 opposite to the first propeller root 111, the first propeller pressure surface 113 and the first propeller suction surface 114 opposite to each other, a first propeller leading edge 115 connecting one edge of the first propeller pressure surface 113 and one edge of the first propeller suction surface 114, a first propeller trailing edge 116 connecting another edge of the first propeller pressure surface 113 and another edge of the first propeller suction surface 114, and a first propeller backward-sweeping portion 1121 formed at the first propeller tip 112. The first propeller tip 112 can be configured to extend obliquely along the span direction of the first propeller blade 11 toward the side where the first propeller suction surface 114 is located, and the first propeller backward-sweeping portion 1121 can be configured to extend obliquely from the first propeller leading edge 115 to the first propeller trailing edge 116.

The first propeller pressure surface 113 can refer to a surface of the first propeller blade 11 facing the ground during a normal flight of the aircraft 1000, and the first propeller suction surface 114 can refer to a surface of the first propeller blade 11 facing the sky during the normal flight of the aircraft 1000.

In some embodiments, the first propeller blade 11 can form a first propeller recurve 1122 at a position of the first propeller tip 112, and the first propeller leading edge 115 can be configured to extend obliquely from the first propeller recurve 1122 along the span direction of the first propeller blade 11 toward the side where the first propeller suction surface 114 is located. As shown in FIG. 2, the position of the first propeller recurve 1122 is represented by MM.

In some embodiments, the first propeller trailing edge 116 can be convex to form a curved first propeller arching portion 1161 proximal to the first propeller root 111 to further improve a pulling force of the first propeller 10.

In some embodiments, the first propeller 10 further includes a first propeller hub 12 and at least two first propeller blades 11. The at least two first propeller blades 11 can be connected to the first propeller hub 12 and centrosymmetric to each other about a center of the first propeller hub 12. Therefore, a balance of the first propeller 10 can be improved. The first propeller hub 12 may have a cylindrical shape, or a cross section of the first propeller hub 12 may have an oval shape, a rhombus shape, or the like. The center of the first propeller hub 12 can include a connecting hole configured to sleeve an output end of the motor. Each first propeller blade 11 may have an elongated shape, and each first propeller blade 11 can be connected to the first propeller hub 12 and extend along a radial direction of the first propeller hub 12.

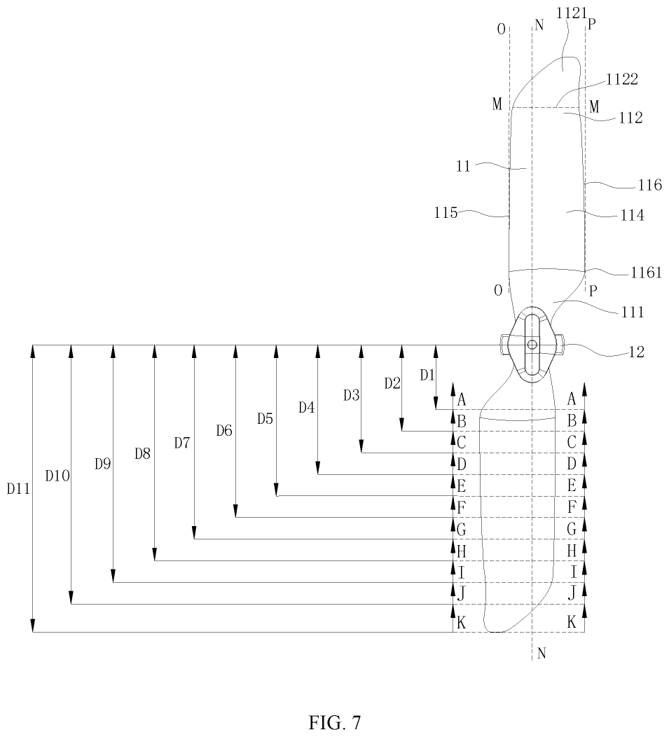

As shown in FIG. 7, in some embodiments, the first propeller blade 11 has a first propeller center axis NN passing through the center of the first propeller hub 12, and the first propeller leading edge 115 has a first propeller leading edge tangent line OO parallel to the first propeller center axis NN. The first propeller trailing edge 116 has a first propeller trailing edge tangent line PP parallel to the first propeller center axis NN, and the first propeller backward-sweeping portion 1121 can be located between the first propeller leading edge tangent line OO and the first propeller trailing edge tangent line PP. As such, the first propeller backward-sweeping portion 1121 can reduce turbulence and downwash airflow generated by the first propeller blade 11, thereby reducing the turbulence and downwash airflow impacting the housing of the aircraft 1000. An air resistance of the first propeller 10 can be reduced, a maneuverability of the aircraft 1000 can be improved, the aircraft 1000 can be more stable, and an overall noise of the aircraft 1000 can be further reduced.

In some embodiments, a side surface of a free end of the first propeller tip 112 can be flat, and thus, an appearance of the first propeller 11 can be further improved.

In some embodiments, a distance from the first propeller recurve 1122 to the center of the first propeller hub 12 can be 82.5% of a radius of the first propeller 10. As such, the first propeller curve 1122 can be far away from the center of the first propeller hub 12, thereby improving the overall appearance of the first propeller 10.

In some embodiments, the first propeller suction surface 114 and the first propeller pressure surface 113 can have curved surfaces. The first propeller suction surface 114 and the first propeller pressure surface 113 having the curved aerodynamic shapes can prevent the turbulence and downwash generated by each portion of the first propeller blade 11 from directly impacting the housing of the aircraft 1000, thereby reducing the overall noise of the aircraft 1000.

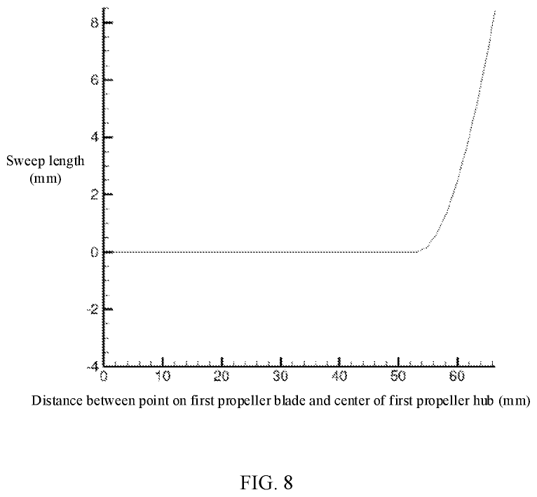

FIG. 8 is a parameter diagram of the first propeller backward-sweeping portion 1121 of the first propeller 10 in FIG. 2 extending obliquely from the first propeller leading edge 115 of the first propeller 10 to the first propeller trailing edge 116. Referring to Table 1, and FIGS. 7 and 8, in some embodiments, the first propeller backward-sweeping portion 1121 can obliquely extend from the first propeller leading edge 115 to the first propeller trailing edge 116. An abscissa of FIG. 8, e.g., blade radius (mm), can represent a distance from a certain position of the first propeller blade 11 (e.g., a position at MM) to the center of the first propeller hub 12 along the span direction of the first propeller blade 11. An ordinate of FIG. 8, Sweep Length (mm), represents a backward sweeping distance or a forward sweeping distance. A positive value of the ordinate Sweep Length (mm) corresponds to backward sweeping, and a negative value corresponds to forward sweeping.

TABLE 1

| | | | | | | | | | | |
|---|---|---|---|---|---|---|---|---|---|---|
| Distance between point on first | 0 | 1.6625 | 3.325 | 4.9875 | 6.65 | 8.3125 | 9.975 | 11.6375 | 13.3 | 14.9625 |
| propeller blade and center of first | | | | | | | | | | |
| propeller hub (mm) | | | | | | | | | | |
| Sweep length (mm) | 0 | 0 | 0 | 0 | 0 | 0 | 0 | 0 | 0 | 0 |
| Distance between point on first | 16.625 | 18.2875 | 19.95 | 21.6125 | 23.275 | 24.9375 | 26.6 | 28.2625 | 29.925 | 31.5875 |
| propeller blade and center of first | | | | | | | | | | |
| propeller hub (mm) | | | | | | | | | | |
| Sweep length (mm) | 0 | 0 | 0 | 0 | 0 | 0 | 0 | 0 | 0 | 0 |
| Distance between point on first | 33.25 | 34.9125 | 36.575 | 38.2375 | 39.9 | 41.5625 | 43.225 | 44.8875 | 46.55 | 48.2125 |
| propeller blade and center of first | | | | | | | | | | |
| propeller hub (mm) | | | | | | | | | | |
| Sweep length (mm) | 0 | 0 | 0 | 0 | 0 | 0 | 0 | 0 | 0 | 0 |
| Distance between point on first | 49.875 | 51.5375 | 53.2 | 54.8625 | 56.525 | 58.1875 | 59.85 | 61.5125 | 63.175 | 64.8375 |
| propeller blade and center of first | | | | | | | | | | |
| propeller hub (mm) | | | | | | | | | | |
| Sweep length (mm) | 0 | 0 | 0 | 0.1546 | 0.6056 | 1.3330 | 2.3171 | 3.5382 | 4.9766 | 6.6124 |
| Distance between point on first | 66.5 | | | | | | | | | |
| propeller blade and center of first | | | | | | | | | | |
| propeller hub (mm) | | | | | | | | | | |
| Sweep length (mm) | 8.4260 | | | | | | | | | |

As shown in Table 1, at a position where the distance between the first propeller blade 11 and the center of the first propeller hub 12 is 54.8625 mm, the first propeller backward-sweeping portion 1121 can start to extend obliquely from the first propeller leading edge 115 to the first propeller trailing edge 116. When a plurality of first propeller blades 11 operate at the same time, each of the first blade backward-sweeping portion 1121 can regularly extend from the first blade leading edge 115 to the first blade trailing edge 116. As such, the turbulence and downwash airflow generated by interactions of the plurality of first propeller blades 11 can be reduced, the turbulence and downwash airflow impacting the housing of the aircraft 1000 can be reduced, the air resistance of the first propeller blade 11 can be reduced, and the maneuverability of the aircraft 1000 can be improved, thereby causing the aircraft 1000 to be more stable. The noise generated by the impact of turbulence and downwash airflow on the housing of the aircraft 1000 can be further reduced.

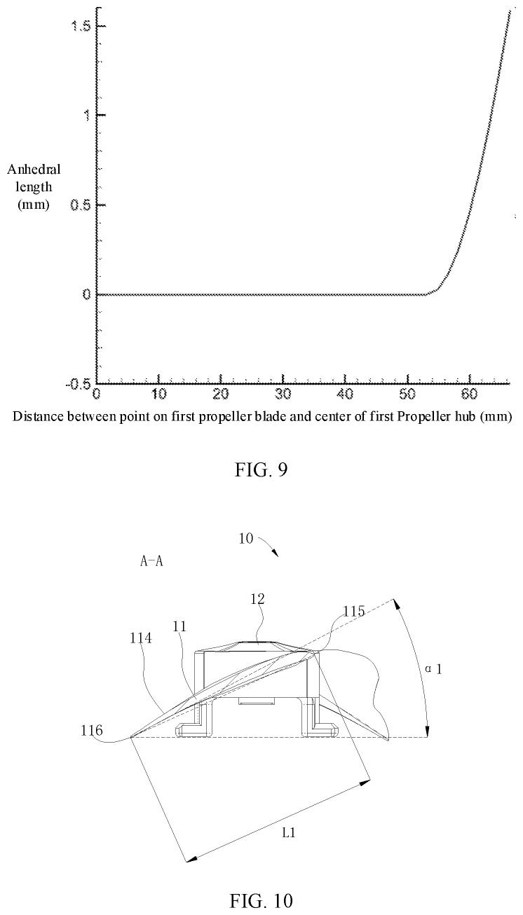

FIG. 9 is a parameter diagram of the first propeller leading edge 115 of the first propeller 10 in FIG. 2 extending obliquely along the span direction of the first propeller blade 11 toward the side where the first propeller suction surface 114 of the first propeller 10 is located. Referring to Table 2, and FIGS. 7 and 9, in some embodiments, the first propeller tip 112 can extend obliquely along the span direction of the first propeller blade 11 toward the side where the first propeller suction surface 114 is located. An abscissa of FIG. 9, e.g., blade radius (mm), can represent the distance from a certain position of the first propeller blade 11 (e.g., a position at MINI) to the center of the first propeller hub 12 along the span direction of the first propeller blade 11. A start point can refer to the center of the first propeller hub 12, and the distance between the start point of the first propeller blade 11 and the center of the first propeller hub 12 is 0 mm. An end point can refer to a free end of the first propeller tip 112, and the distance between the free end and the center of the first hub 12 is 66.5 mm. An ordinate of FIG. 9, Anhedral Length (mm), represents an anhedral distance or a dihedral distance. A positive value of the ordinate Anhedral Length (mm) corresponds to dihedral, and a negative value corresponds to anhedral.

TABLE 2

| | | | | | | | | | | |
|---|---|---|---|---|---|---|---|---|---|---|
| Distance between point on first | 0 | 1.6625 | 3.325 | 4.9875 | 6.65 | 8.3125 | 9.975 | 11.6375 | 13.3 | 14.9625 |
| propeller blade and center of first | | | | | | | | | | |
| propeller hub (mm) | | | | | | | | | | |
| Dihedral distance (mm) | 0 | 0 | 0 | 0 | 0 | 0 | 0 | 0 | 0 | 0 |
| Distance between point on first | 16.625 | 18.2875 | 19.95 | 21.6125 | 23.275 | 24.9375 | 26.6 | 28.2625 | 29.925 | 31.5875 |
| propeller blade and center of first | | | | | | | | | | |
| propeller hub (mm) | | | | | | | | | | |
| Dihedral distance (mm) | 0 | 0 | 0 | 0 | 0 | 0 | 0 | 0 | 0 | 0 |
| Distance between point on first | 33.25 | 34.9125 | 36.575 | 38.2375 | 39.9 | 41.5625 | 43.225 | 44.8875 | 46.55 | 48.2125 |
| propeller blade and center of first | | | | | | | | | | |
| propeller hub (mm) | | | | | | | | | | |
| Dihedral distance (mm) | 0 | 0 | 0 | 0 | 0 | 0 | 0 | 0 | 0 | 0 |
| Distance between point on first | 49.875 | 51.5375 | 53.2 | 54.8625 | 56.525 | 58.1875 | 59.85 | 61.5125 | 63.175 | 64.8375 |
| propeller blade and center of first | | | | | | | | | | |
| propeller hub (mm) | | | | | | | | | | |
| Dihedral distance (mm) | 0 | 0 | 0 | 0.0291 | 0.1141 | 0.2512 | 0.4366 | 0.6668 | 0.9379 | 1.2462 |
| Distance between point on first | 66.5 | | | | | | | | | |
| propeller blade and center of first | | | | | | | | | | |
| propeller hub (mm) | | | | | | | | | | |
| Dihedral distance (mm) | 1.5879 | | | | | | | | | |

As shown in Table. 2, at the position where the distance between the first propeller blade 11 and the center of the first propeller hub 12 is 54.8625 mm, the first propeller leading edge 115 can start to extend obliquely along the span direction of the first propeller blade 11 toward the side where the first propeller suction surface 114 of the first propeller 10 is located. That is, the first propeller blade 11 can start to be dihedral at the position where the distance between the first propeller blade 11 and the center of the first propeller hub 12 is 54.8625 mm. When the plurality of first propeller blades 11 operate at the same time, each of the first propeller leading edge 115 can regularly extend from the first propeller recurve 1122 along the span direction of the first propeller blade 11 toward the side where the first propeller suction surface 114 of the first propeller 10 is located. As such, the turbulence and downwash airflow generated by the interactions of the plurality of first propeller blades 11 can be reduced, and the turbulence and downwash airflow impacting the housing of the aircraft 1000 can be reduced. Furthermore, a lift point of the first propeller blade 11 can be rated, such that the aircraft 1000 can automatically correct a flight attitude, increase an inertial stability of the aircraft 1000, thereby causing the aircraft 1000 to fly more smoothly. The noise generated by the impact of turbulence and downwash airflow on the housing of the aircraft 1000 can be further reduced.

FIG. 10 is a cross-sectional view of the first propeller 10 along A-A line in FIG. 7 at a distance of 15 mm from the center of the first propeller hub 12. As shown in FIGS. 7 and 10, in some embodiments, at D1 where the distance from the center of the first propeller hub 12 equals to 22.6% of the radius of the first propeller 10, a first propeller angle of attack (AOA) α1 of the first propeller blade 11 is 27.69°±2.5°, and a first chord length L1 of the first propeller blade 11 is 18.64 mm±5 mm. The air resistance of the first propeller 10 can be further reduced, the pulling force and efficiency can be improved, and the noise can be reduced. The first propeller AOA α1 of the first propeller blade 11 can be 25.19°, 27.69°, or 30.19°, or any one of or any value between two of 25.69°, 26.19°, 26.69°, 27.19°, 28.19°, 28.69°, 29.19°, 29.69°, and the like. The first chord length L1 of the first propeller blade 11 can be 13.64 mm, 18.64 mm, or 23.64 mm, or any one of or any value between two of 14.64 mm, 15.64 mm, 16.64 mm, 17.64 mm, 19.64 mm, 20.64 mm, 21.64 mm, 22.64 mm, and the like.

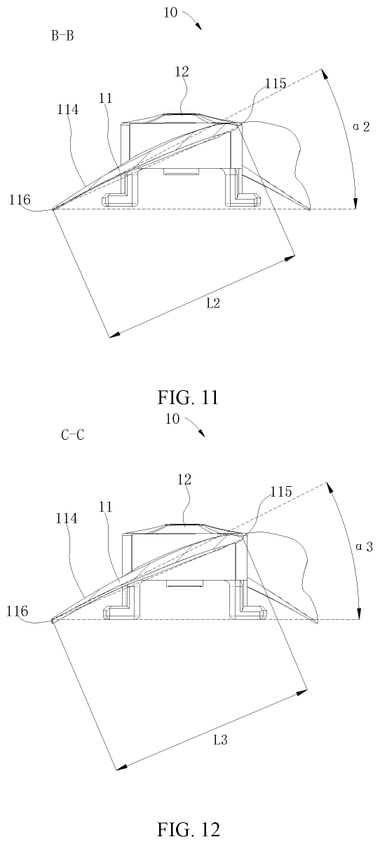

FIG. 11 is a cross-sectional view of the first propeller 10 along B-B line in FIG. 7 at a distance of 20 mm from the center of the first propeller hub 12. As shown in FIGS. 7 and 11, in some embodiments, at D2 where the distance the center of the first propeller hub 12 equals to 30.1% of the radius of the first propeller 10, a first propeller AOA α2 of the first propeller blade 11 is 27.51°±2.5°, and a first chord length L2 of the first propeller blade 11 is 19.23 mm±5 mm. The air resistance of the first propeller 10 can be further reduced, the pulling force and efficiency can be improved, and the noise can be reduced. The first propeller AOA α2 of the first propeller blade 11 can be 25.01°, 27.51°, or 30.01°, or any one of or any value between two of 25.51°, 26.01°, 26.51°, 27.01°, 28.01°, 28.51°, 29.01°, 29.51°, and the like. The first chord length L2 of the first propeller blade 11 can be 14.23 mm, 19.23 mm, or 24.23 mm, or any one of or any value between two of 15.23 mm, 16.23 mm, 17.23 mm, 18.23 mm, 20.23 mm, 21.23 mm, 22.23 mm, 23.23 mm, and the like.

FIG. 12 is a cross-sectional view of the first propeller 10 along C-C line in FIG. 7 at a distance of 25 mm from the center of the first propeller hub 12. As shown in FIGS. 7 and 12, in some embodiments, at D3 where the distance from the center of the first propeller hub 12 equals to 37.6% of the radius of the first propeller 10, a first propeller AOA α3 of the first propeller blade 11 is 26.61°±2.5°, and a first chord length L3 of the first propeller blade 11 is 19.07 mm±5 mm. The air resistance of the first propeller 10 can be further reduced, the pulling force and efficiency can be improved, and the noise can be reduced. The first propeller AOA α3 of the first propeller blade 11 can be 24.11°, 26.61°, or 29.11°, or any one of or any value between two of 24.61°, 25.11°, 25.61°, 26.11°, 27.11°, 27.61°, 28.11°, 28.61°, and the like. The first chord length L3 of the first propeller blade 11 can be 14.07 mm, 19.07 mm, or 24.07 mm, or any one of or any value between two of 15.07 mm, 16.07 mm, 17.07 mm, 18.07 mm, 20.07 mm, 21.07 mm, 22.07 mm, 23.07 mm, and the like.

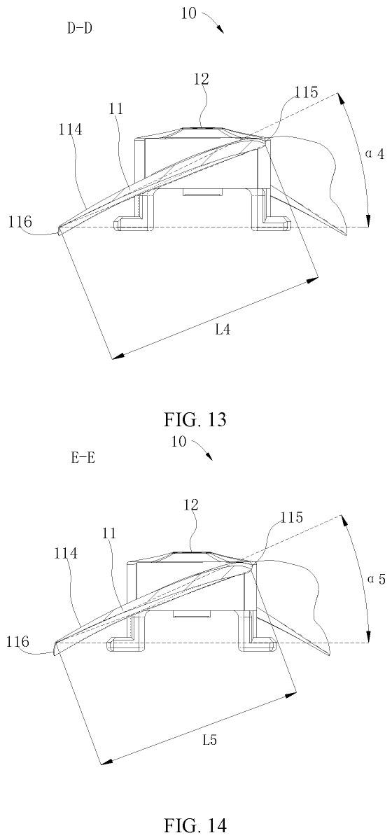

FIG. 13 a cross-sectional view of the first propeller 10 along D-D line in FIG. 7 at a distance of 30 mm from the center of the first propeller hub 12. As shown in FIGS. 7 and 13, in some embodiments, at D4 where the distance from the center of the first propeller hub 12 equals to 45.1% of the radius of the first propeller 10, a first propeller AOA α4 of the first propeller blade 11 is 25.78°±2.5°, and a first chord length L4 of the first propeller blade 11 is 18.80 mm±5 mm. The air resistance of the first propeller 10 can be further reduced, the pulling force and efficiency can be improved, and the noise can be reduced. The first propeller AOA α4 of the first propeller blade 11 can be 23.28°, 25.78°, or 28.28°, or any one of or any value between two of 23.78°, 24.28°, 24.78°, 25.28°, 26.28°, 26.78°, 27.28°, 27.78°, and the like. The first chord length L4 of the first propeller blade 11 can be 13.80 mm, 18.80 mm, or 23.80 mm, or any one of or any value between two of 14.80 mm, 15.80 mm, 16.80 mm, 17.80 mm, 19.80 mm, 20.80 mm, 21.80 mm, 22.80 mm, and the like.

FIG. 14 is a cross-sectional view of the first propeller 10 along E-E line in FIG. 7 at a distance of 35 mm from the center of the first propeller hub 12. As shown in FIGS. 7 and 14, in some embodiments, at D5 where the distance from the center of the first propeller hub 12 equals to 52.6% of the radius of the first propeller 10, a first propeller AOA α5 of the first propeller blade 11 is 24.10°±2.5°, and a first chord length L5 of the first propeller blade 11 is 18.44 mm±5 mm. The air resistance of the first propeller 10 can be further reduced, the pulling force and efficiency can be improved, and the noise can be reduced. The first propeller AOA α5 of the first propeller blade 11 can be 21.60°, 24.10°, or 26.60°, or any one of or any value between two of 21.10°, 22.60°, 23.10°, 23.60°, 24.60°, 25.10°, 25.60°, 26.10°, and the like. The first chord length L5 of the first propeller blade 11 can be 13.44 mm, 18.44 mm, or 23.44 mm, or any one of or any value between two of 14.44 mm, 15.44 mm, 16.44 mm, 17.44 mm, 19.44 mm, 20.44 mm, 21.44 mm, 22.44 mm, and the like.

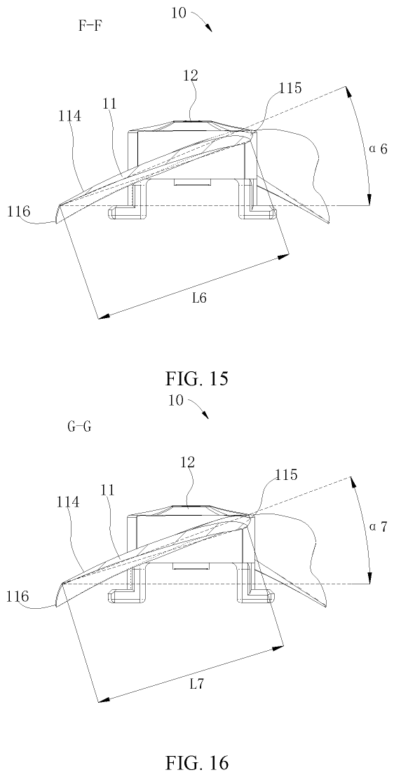

FIG. 15 a cross-sectional view of the first propeller 10 along F-F line in FIG. 7 at a distance of 40 mm from the center of the first propeller hub 12. As shown in FIGS. 7 and 15, in some embodiments, at D6 where the distance from the center of the first propeller hub 12 equals to 60.2% of the radius of the first propeller 10, a first propeller AOA α6 of the first propeller blade 11 is 22.63°±2.5°, and a first chord length L6 of the first propeller blade 11 is 18.00 mm±5 mm. The air resistance of the first propeller 10 can be further reduced, the pulling force and efficiency can be improved, and the noise can be reduced. The first propeller AOA α6 of the first propeller blade 11 can be 20.13°, 22.63°, or 25.13°, or any one of or any value between two of 20.63°, 21.13°, 21.63°, 22.13°, 23.13°, 23.63°, 24.13°, 24.63°, and the like. The first chord length L6 of the first propeller blade 11 can be 13.00 mm, 18.00 mm, or 23.00 mm, or any one of or any value between two of 14.00 mm, 15.00 mm, 16.00 mm, 17.00 mm, 19.00 mm, 20.00 mm, 21.00 mm, 22.00 mm, and the like.

FIG. 16 is a cross-sectional view of the first propeller 10 along G-G line in FIG. 7 at a distance of 30 mm from the center of the first propeller hub 12. As shown in FIGS. 7 and 16, in some embodiments, at D7 where the distance from the center of the first propeller hub 12 equals to 67.7% of the radius of the first propeller 10, a first propeller AOA α7 of the first propeller blade 11 is 20.41°±2.5°, and a first chord length L7 of the first propeller blade 11 is 17.49 mm±5 mm. The air resistance of the first propeller 10 can be further reduced, the pulling force and efficiency can be improved, and the noise can be reduced. The first propeller AOA α7 of the first propeller blade 11 can be 17.91°, 20.41°, or 22.91°, or any one of or any value between two of 18.41°, 18.91°, 19.41°, 19.91°, 20.91°, 21.41°, 21.91°, 22.41°, and the like. The first chord length L7 of the first propeller blade 11 can be 12.49 mm, 17.49 mm, or 22.49 mm, or any one of or any value between two of 13.49 mm, 14.49 mm, 15.49 mm, 16.49 mm, 18.49 mm, 19.49 mm, 20.49 mm, 21.49 mm, and the like.

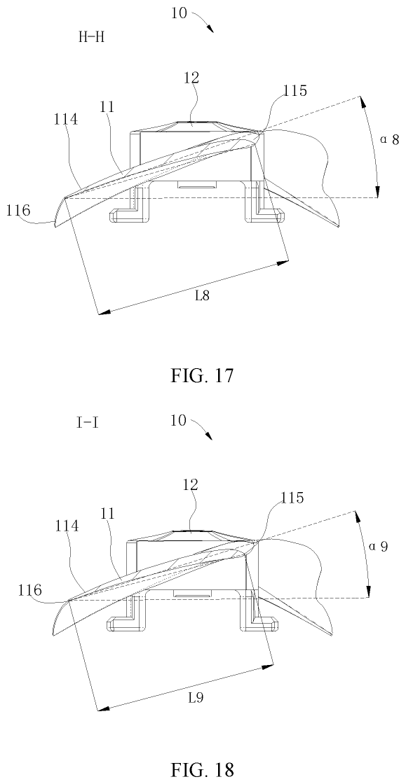

FIG. 17 is a cross-sectional view of the first propeller 10 along H-H line in FIG. 7 at a distance of 50 mm from the center of the first propeller hub 12. As shown in FIGS. 7 and 17, in some embodiments, at D8 where the distance from the center of the first propeller hub equals to 75.2% of the radius of the first propeller 10, a first propeller AOA α8 of the first propeller blade 11 is 19.19°±2.5°, and a first chord length L8 of the first propeller blade 11 is 17.01 mm±5 mm. The air resistance of the first propeller 10 can be further reduced, the pulling force and efficiency can be improved, and the noise can be reduced. The first propeller AOA α8 of the first propeller blade 11 can be 16.69°, 19.19°, or 21.69°, or any one of or any value between two of 17.19°, 17.69°, 18.19°, 18.69°, 19.69°, 20.19°, 20.69°, 21.19°, and the like. The first chord length L8 of the first propeller blade 11 can be 12.01 mm, 17.01 mm, or 22.01 mm, or any one of or any value between two of 13.01 mm, 14.01 mm, 15.01 mm, 16.01 mm, 18.01 mm, 19.01 mm, 20.01 mm, 21.01 mm, and the like.

FIG. 18 is a cross-sectional view of the first propeller 10 along I-I line in FIG. 7 at a distance of 55 mm from the center of the first propeller hub 12. As shown in FIGS. 7 and 18, in some embodiments, at D9 where the distance from the center of the first propeller hub 12 equals to 82.7% of the radius of the first propeller 10, a first propeller AOA α9 of the first propeller blade 11 is 16.80°±2.5°, and a first chord length L9 of the first propeller blade 11 is 15.90 mm±5 mm. The air resistance of the first propeller 10 can be further reduced, the pulling force and efficiency can be improved, and the noise can be reduced. The first propeller AOA α9 of the first propeller blade 11 can be 14.30°, 16.80°, or 19.30°, or any one of or any value between two of 14.80°, 15.30°, 15.80°, 16.30°, 17.30°, 17.80°, 18.30°, 18.80°, and the like. The first chord length L9 of the first propeller blade 11 can be 10.90 mm, 15.90 mm, or 20.90 mm, or any one of or any value between two of 11.90 mm, 12.90 mm, 13.90 mm, 14.90 mm, 16.90 mm, 17.90 mm, 18.90 mm, 19.90 mm, and the like.

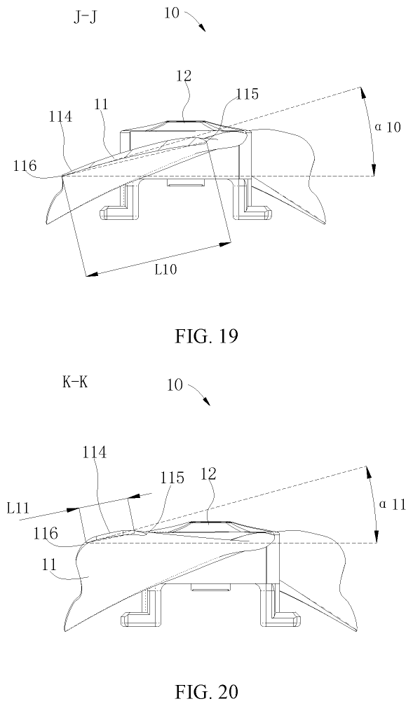

FIG. 19 is a cross-sectional view of the first propeller 10 along J-J line in FIG. 7 at a distance of 60 mm from the center of the first propeller hub 12. As shown in FIGS. 7 and 19, in some embodiments, at D10 where the distance from the center of the first propeller hub 12 equals to 90.2% of the radius of the first propeller 10, a first propeller AOA α10 of the first propeller blade 11 is 16.77°±2.5°, and a first chord length L10 of the first propeller blade 11 is 13.04 mm±5 mm. The air resistance of the first propeller 10 can be further reduced, the pulling force and efficiency can be improved, and the noise can be reduced. The first propeller AOA α10 of the first propeller blade 11 can be 14.27°, 16.77°, or 19.27°, or any one of or any value between two of 14.77°, 15.27°, 15.77°, 16.27°, 17.27°, 17.77°, 18.27°, 18.77°, and the like. The first chord length L10 of the first propeller blade 11 can be 8.04 mm, 13.04 mm, or 18.04 mm, or any one of or any value between two of 9.04 mm, 10.04 mm, 11.04 mm, 12.04 mm, 14.04 mm, 15.04 mm, 16.04 mm, 17.04 mm, and the like.

FIG. 20 is a cross-sectional view of the first propeller 10 along K-K line in FIG. 7 at a distance of 66.5 mm from the center of the first propeller hub 12. As shown in FIGS. 7 and 20, in some embodiments, at D11 where the distance from the center of the first propeller hub 12 equals to 100% of the radius of the first propeller 10, a first propeller AOA all of the first propeller blade 11 is 15.30°±2.5°, and a first chord length L11 of the first propeller blade 11 is 4.15 mm±2 mm. The air resistance of the first propeller 10 can be further reduced, the pulling force and efficiency can be improved, and the noise can be reduced. The first propeller AOA all of the first propeller blade 11 can be 12.80°, 15.30°, or 17.80°, or any one of or any value between two of 13.30°, 13.80°, 14.30°, 14.80°, 15.80°, 16.30°, 16.80°, 17.30°, and the like. The first chord length L11 of the first propeller blade 11 can be 2.15 mm, 4.15 mm, or 6.15 mm, or any one of or any value between two of 2.65 mm, 3.15 mm, 3.65 mm, 4.65 mm, 5.15 mm, 5.65 mm, and the like.

Referring again to FIGS. 7 and 10, in some embodiments, the diameter of the first propeller 10 is 133 mm±13.3 mm. At D1 15 mm from the center of the first propeller hub 12, the first propeller AOA α1 of the first propeller blade 11 is 27.69°, and the first chord length L1 of the first propeller blade 11 is 18.64 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 11, in some embodiments, the diameter of the first propeller 10 is 133 mm±13.3 mm. At D2 20 mm from the center of the first propeller hub 12, the first propeller AOA α2 of the first propeller blade 11 is 27.51°, and the first chord length L2 of the first propeller blade 11 is 19.23 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 12, in some embodiments, the diameter of the first propeller 10 is 133 mm±13.3 mm. At D3 25 mm from the center of the first propeller hub 12, the first propeller AOA α3 of the first propeller blade 11 is 26.61°, and the first chord length L3 of the first propeller blade 11 is 19.07 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 13, in some embodiments, the diameter of the first propeller 10 is 133 mm±13.3 mm. At D4 30 mm from the center of the first propeller hub 12, the first propeller AOA α4 of the first propeller blade 11 is 25.78°, and the first chord length L4 of the first propeller blade 11 is 18.80 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 14, in some embodiments, the diameter of the first propeller 10 is 133 mm±13.3 mm. At D5 35 mm from the center of the first propeller hub 12, the first propeller AOA α5 of the first propeller blade 11 is 24.10°, and the first chord length L5 of the first propeller blade 11 is 18.44 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 15, in some embodiments, the diameter of the first propeller 10 is 133 mm±13.3 mm. At D6 40 mm from the center of the first propeller hub 12, the first propeller AOA α6 of the first propeller blade 11 is 22.63°, and the first chord length L6 of the first propeller blade 11 is 18.00 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 16, in some embodiments, the diameter of the first propeller 10 is 133 mm±13.3 mm. At D7 45 mm from the center of the first propeller hub 12, the first propeller AOA α7 of the first propeller blade 11 is 20.41°, and the first chord length L7 of the first propeller blade 11 is 17.49 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 17, in some embodiments, the diameter of the first propeller 10 is 133 mm±13.3 mm. At D8 50 mm from the center of the first propeller hub 12, the first propeller AOA α8 of the first propeller blade 11 is 19.19°, and the first chord length L8 of the first propeller blade 11 is 17.01 mm. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 18, in some embodiments, the diameter of the first propeller 10 is 133 mm±13.3 mm. At D9 55 mm from the center of the first propeller hub 12, the first propeller AOA α9 of the first propeller blade 11 is 16.80°, and the first chord length L9 of the first propeller blade 11 is 15.90 mm. The air resistance of the first propeller 10 can be further reduced, the pulling force and efficiency can be improved, and the noise can be reduced. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 19, in some embodiments, the diameter of the first propeller 10 is 133 mm±13.3 mm. At D10 60 mm from the center of the first propeller hub 12, the first propeller AOA α10 of the first propeller blade 11 is 16.77°, and the first chord length L10 of the first propeller blade 11 is 13.04 mm. The air resistance of the first propeller 10 can be further reduced, the pulling force and efficiency can be improved, and the noise can be reduced. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 and 20, in some embodiments, the diameter of the first propeller 10 is 133 mm±13.3 mm. At D11 66.5 mm from the center of the first propeller hub 12, the first propeller AOA all of the first propeller blade 11 is 15.30°, and the first chord length L11 of the first propeller blade 11 is 4.15 mm. The air resistance of the first propeller 10 can be further reduced, the pulling force and efficiency can be improved, and the noise can be reduced. The diameter of the first propeller 10 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

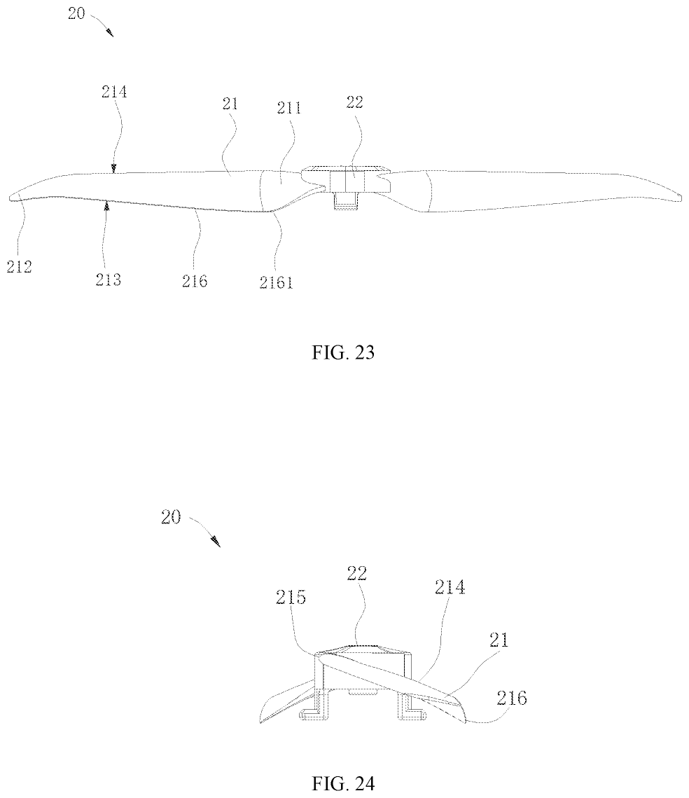

The structure of the second propeller 20 can be mirror-symmetrical to the structure of the first propeller 10. FIG. 21 is a perspective view of the second propeller 20 of the propeller assembly 100 in FIG. 1. FIG. 22 is another perspective view of the second propeller 20 of the propeller assembly 100 in FIG. 1. FIGS. 23 to 26 are schematic plan views of the second propeller 20 of the propeller assembly 100 in FIG. 1. As shown in FIGS. 21 to 26, the second propeller 20 includes the second propeller blade 21. The second propeller blade 21 includes the second propeller root 211, the second propeller tip 212 opposite to the second propeller root 111, and the second propeller pressure surface 213 and the second propeller suction surface 214 opposite to each other, a second propeller leading edge 215 connecting one edge of the second propeller pressure surface 213 and one edge of the second propeller suction surface 214, a second propeller trailing edge 216 connecting another edge of the second propeller pressure surface 213 and another edge of the second propeller suction surface 214, and a second propeller backward-sweeping portion 2121 formed at the first propeller tip 212. The first propeller tip 212 can be configured to extend obliquely along the span direction of the second propeller blade 21 toward the side where the second propeller suction surface 214 is located, and the second propeller backward-sweeping portion 2121 can be configured to extend obliquely from the second propeller leading edge 215 to the second propeller trailing edge 216.

The second propeller pressure surface 213 can refer to a surface of the second propeller blade 21 facing the ground during the normal flight of the aircraft 1000, and the second propeller suction surface 214 can refer to a surface of the second propeller blade 21 facing the sky during the normal flight of the aircraft 1000.

In some embodiments, the second propeller blade 21 can form a second propeller recurve 2122 at a position of the second propeller tip 212, and the second propeller leading edge 215 can be configured to extend obliquely from the second propeller recurve 2122 along the span direction of the second propeller blade 21 toward the side where the second propeller pressure surface 213 is located. As shown in FIG. 21, the position of the second propeller recurve 2122 is represented by QQ.

In some embodiments, the second propeller trailing edge 216 can be convex to form a curved second propeller arching portion 2161 proximal to the second propeller root 211 to further improve a pulling force of the second propeller 20.

In some embodiments, the second propeller 20 further includes a second propeller hub 22 and at least two second propeller blades 21. The at least two second propeller blades 21 can be connected to the second propeller hub 22 and centrosymmetric to each other about a center of the second propeller hub 22. Therefore, a balance of the second propeller 20 can be improved. The second propeller hub 22 may have a cylindrical shape, or a cross section of the second propeller hub 22 may have an oval shape, a rhombus shape, or the like. The center of the second propeller hub 22 can include a connecting hole configured to sleeve an output end of the motor. Each second propeller blade 21 may have an elongated shape, and each second propeller blade 21 can be connected to the second propeller hub 22 and extend along a radial direction of the second propeller hub 22.

In some embodiments, the second propeller blade 21 can have a second propeller center axis passing through the center of the second propeller hub 22, and the second propeller leading edge 215 can have a second propeller leading edge tangent line parallel to the second propeller center axis. The second propeller trailing edge 216 can have a second propeller trailing edge tangent line parallel to the second propeller center axis, and the second propeller backward-sweeping portion 2121 can be located between the second propeller leading edge tangent line and the second propeller trailing edge tangent line. As such, the second propeller backward-sweeping portion 2121 can reduce the turbulence and downwash airflow generated by the second propeller blade 21, thereby reducing the turbulence and downwash airflow impacting the housing of the aircraft 1000. An air resistance of the second propeller 10 can be reduced, the maneuverability of the aircraft 1000 can be improved, the aircraft 1000 can be more stable, and the overall noise of the aircraft 1000 can be further reduced.

In some embodiments, a side surface of a free end of the second propeller tip 212 can be flat, and thus, an appearance of the second propeller 21 can be further improved.

In some embodiments, a distance from the second propeller recurve 2122 to the center of the second propeller hub 22 can be 82.5% of a radius of the second propeller 10. As such, the first propeller curve 1122 can be far away from the center of the first propeller hub 22, thereby improving the overall appearance of the second propeller 20.

In some embodiments, the second propeller suction surface 214 and the second propeller pressure surface 213 can have curved surfaces. The second propeller suction surface 214 and the second propeller pressure surface 213 having the curved aerodynamic shapes can prevent the turbulence and downwash generated by each portion of the second propeller blade 21 from directly impacting the housing of the aircraft 1000, thereby reducing the overall noise of the aircraft 1000.

In some embodiments, a rotation direction of the first propeller 10 can be opposite to a rotation direction of the second propeller 20. Due to a spin torque generated when the first propeller 10 or the second propeller 20 rotates individually, the aircraft 1000 can spin. Therefore, if the rotation direction of the first propeller 10 and the rotation direction of the second propeller 20 can be opposite, the spin torques generated by the rotation of the first propeller 10 and the rotation of the second propeller 20 can be offset, thereby causing the aircraft 1000 to fly more smoothly.

In some embodiments, the first propeller 10 can include a forward propeller, and the second propeller 20 can include a reverse propeller. For example, the first propeller 10 can include a propeller rotating counterclockwise to generate the lift, and the second propeller 20 can include a propeller rotating clockwise to generate the lift.

In some embodiments, the propeller assembly 100 can include a multi-rotor propeller assembly, and the first propeller 10 can be neighboring to the second propeller 20. For example, the multi-rotor propeller assembly can simultaneously install the plurality of first propellers 10 and the plurality of second propellers 20. The plurality of first propellers 10 and the plurality of second propellers 20 can be alternately arranged to offset the spin torques generated by the rotation of each first propeller 10 and the rotation of each second propeller 20, such that the aircraft 1000 can fly more smoothly.

In some embodiments, the propeller assembly 100 can include a four-rotor propeller assembly having two first propellers 10 and two second propellers 20, and each first propeller 10 can be arranged neighboring to the two second propellers 20. For example, the four-rotor propeller assembly can include two first propellers 10 and two second propellers 20 at the same time. The first propellers 10 and the second propellers 20 can be diagonally distributed. That is, each first propeller 10 can be arranged neighboring to the two second propellers 20 and each second propeller 20 can be arranged neighboring to the two first propellers 10. Since the rotation directions of the two first propellers 10 and the two second propellers 20 are different, for example, the two first propellers 10 can rotate counterclockwise at the same time, the two second propellers 20 can rotate clockwise at the same time, or the two first propellers 10 can rotate counterclockwise at the same time, and the two second propellers 20 can rotate counterclockwise at the same time, the spin torques can be offset, such that the aircraft 1000 can fly more smoothly.

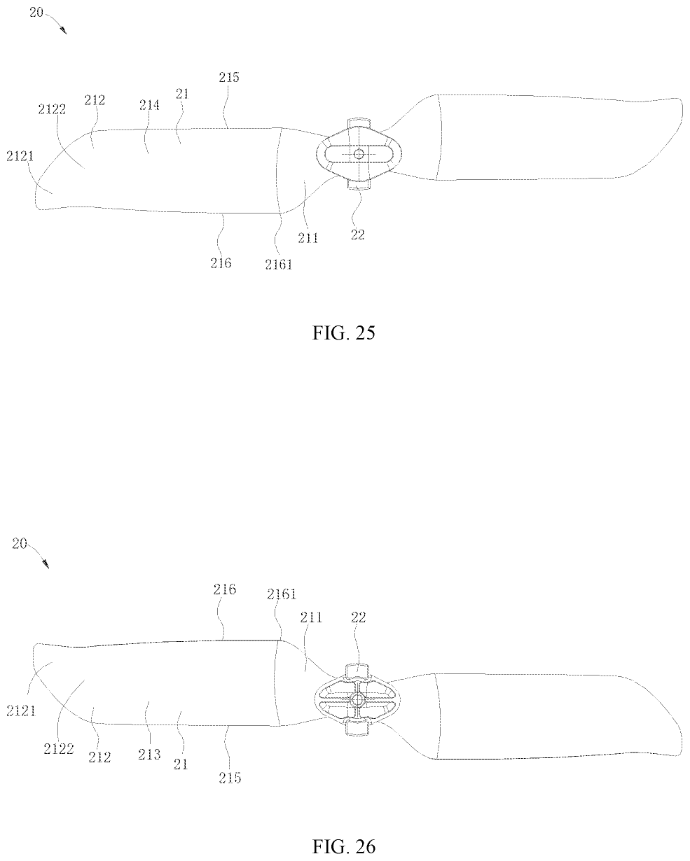

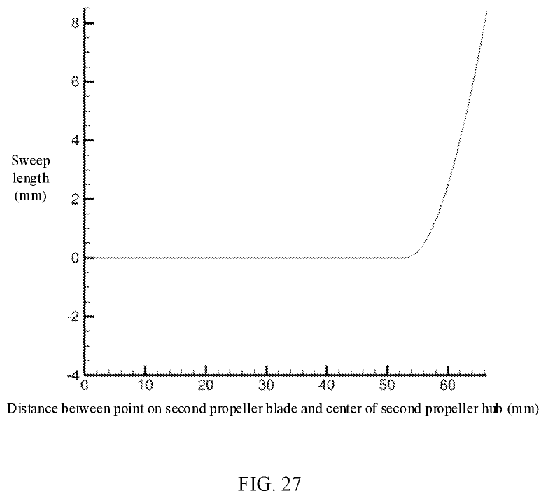

FIG. 27 is a parameter diagram of the second propeller backward-sweeping portion 2121 of the second propeller 20 in FIG. 21 extending obliquely from the second propeller leading edge 215 of the second propeller 20 to the second propeller trailing edge 216 of the second propeller 20. Referring to Table 3, and FIGS. 25 and 27, in some embodiments, the second propeller backward-sweeping portion 2121 can obliquely extend from the second propeller leading edge 215 to the second propeller trailing edge 216. An abscissa of FIG. 27, e.g., blade radius (mm), can represent a distance from a certain position of the second propeller blade 21 (e.g., a position at QQ) to the center of the second propeller hub 22 along the span direction of the second propeller blade 21. An ordinate of FIG. 27, Sweep Length (mm), represents a backward sweeping distance or a forward sweeping distance. A positive value of the ordinate Sweep Length (mm) corresponds to backward sweeping, and a negative value corresponds to forward sweeping.

TABLE 3

| | | | | | | | | | | |
|---|---|---|---|---|---|---|---|---|---|---|
| Distance between point on | 0 | 1.6625 | 3.325 | 4.9875 | 6.65 | 8.3125 | 9.975 | 11.6375 | 13.3 | 14.9625 |
| second propeller blade and center | | | | | | | | | | |
| of second propeller hub (mm) | | | | | | | | | | |
| Sweep length (mm) | 0 | 0 | 0 | 0 | 0 | 0 | 0 | 0 | 0 | 0 |
| Distance between point on | 16.625 | 18.2875 | 19.95 | 21.6125 | 23.275 | 24.9375 | 26.6 | 28.2625 | 29.925 | 31.5875 |
| second propeller blade and center | | | | | | | | | | |
| of second propeller hub (mm) | | | | | | | | | | |
| Sweep length (mm) | 0 | 0 | 0 | 0 | 0 | 0 | 0 | 0 | 0 | 0 |
| Distance between point on | 33.25 | 34.9125 | 36.575 | 38.2375 | 39.9 | 41.5625 | 43.225 | 44.8875 | 46.55 | 48.2125 |
| second propeller blade and center | | | | | | | | | | |
| of second propeller hub (mm) | | | | | | | | | | |
| Sweep length (mm) | 0 | 0 | 0 | 0 | 0 | 0 | 0 | 0 | 0 | 0 |
| Distance between point on | 49.875 | 51.5375 | 53.2 | 54.8625 | 56.525 | 58.1875 | 59.85 | 61.5125 | 63.175 | 64.8375 |
| second propeller blade and center | | | | | | | | | | |
| of second propeller hub (mm) | | | | | | | | | | |
| Sweep length (mm) | 0 | 0 | 0 | 0.1546 | 0.6056 | 1.3330 | 2.3171 | 3.5382 | 4.9766 | 6.6124 |
| Distance between point on | 66.5 | | | | | | | | | |
| second propeller blade and center | | | | | | | | | | |
| of second propeller hub (mm) | | | | | | | | | | |
| Sweep length (mm) | 8.4260 | | | | | | | | | |

As shown in Table 3, at a position where the distance between the second propeller blade 21 and the center of the second propeller hub 22 is 54.8625 mm, the second propeller backward-sweeping portion 2121 can start to extend obliquely from the second propeller leading edge 215 to the second propeller trailing edge 216. When the plurality of second propeller blades 21 operate at the same time, each of the second blade backward-sweeping portion 2121 can regularly extend from the second blade leading edge 215 to the second blade trailing edge 216. As such, the turbulence and downwash airflow generated by interactions of the plurality of second propeller blades 21 can be reduced, the turbulence and downwash airflow impacting the housing of the aircraft 1000 can be reduced, the air resistance of the second propeller blade 21 can be reduced, and the maneuverability of the aircraft 1000 can be improved, thereby causing the aircraft 1000 to be more stable. The noise generated by the impact of turbulence and downwash airflow on the housing of the aircraft 1000 can be further reduced.

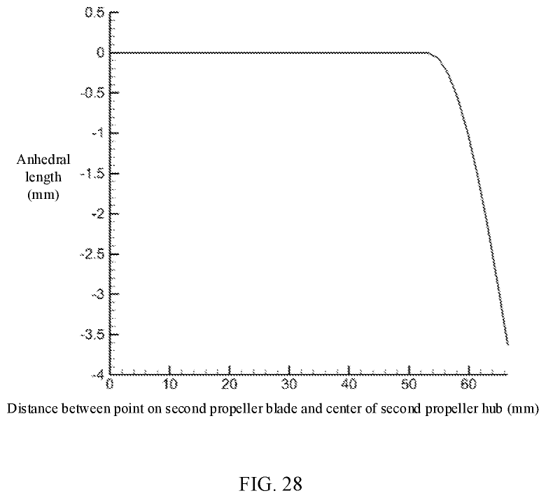

FIG. 28 is a parameter diagram of the second propeller leading edge 215 of the second propeller 20 in FIG. 21 extending obliquely along the span direction of the second propeller blade 21 toward the side where the second propeller suction surface 214 of the second propeller 20 is located. Referring to Table 3, and FIGS. 25 and 28, in some embodiments, the second propeller tip 212 can extend obliquely along the span direction of the second propeller blade 21 toward the side where the second propeller suction surface 214 is located. An abscissa and an ordinate of FIG. 28 are same as the abscissa and the ordinate of FIG. 9, and detailed description thereof is omitted herein. A positive value of the ordinate Anhedral Length (mm) corresponds to dihedral, and a negative value corresponds to anhedral.

TABLE 4

| | | | | | | | | | | |
|---|---|---|---|---|---|---|---|---|---|---|
| Distance between point on | 0 | 1.6625 | 3.325 | 4.9875 | 6.65 | 8.3125 | 9.975 | 11.6375 | 13.3 | 14.9625 |
| second propeller blade and | | | | | | | | | | |
| center of second propeller | | | | | | | | | | |
| hub (mm) | | | | | | | | | | |
| Anhedral distance (mm) | 0 | 0 | 0 | 0 | 0 | 0 | 0 | 0 | 0 | 0 |
| Distance between point on | 16.625 | 18.2875 | 19.95 | 21.6125 | 23.275 | 24.9375 | 26.6 | 28.2625 | 29.925 | 31.5875 |
| second propeller blade and | | | | | | | | | | |
| center of second propeller | | | | | | | | | | |
| hub (mm) | | | | | | | | | | |
| Anhedral distance (mm) | 0 | 0 | 0 | 0 | 0 | 0 | 0 | 0 | 0 | 0 |
| Distance between point on | 33.25 | 34.9125 | 36.575 | 38.2375 | 39.9 | 41.5625 | 43.225 | 44.8875 | 46.55 | 48.2125 |
| second propeller blade and | | | | | | | | | | |
| center of second propeller | | | | | | | | | | |
| hub (mm) | | | | | | | | | | |
| Anhedral distance (mm) | 0 | 0 | 0 | 0 | 0 | 0 | 0 | 0 | 0 | 0 |
| Distance between point on | 49.875 | 51.5375 | 53.2 | 54.8625 | 56.525 | 58.1875 | 59.85 | 61.5125 | 63.175 | 64.8375 |
| second propeller blade and | | | | | | | | | | |
| center of second propeller | | | | | | | | | | |
| hub (mm) | | | | | | | | | | |
| Anhedral distance (mm) | 0 | 0 | 0 | −0.0668 | −0.2615 | −0.5757 | −1.0007 | −1.5281 | −2.1493 | −2.8558 |
| Distance between point on | 66.5 | | | | | | | | | |
| second propeller blade and | | | | | | | | | | |
| center of second propeller | | | | | | | | | | |
| hub (mm) | | | | | | | | | | |
| Anhedral distance (mm) | −3.6391 | | | | | | | | | |

As shown in Table. 4, at the position where the distance between the second propeller blade 21 and the center of the second propeller hub 22 is 54.8625 mm, the second propeller leading edge 215 can start to extend obliquely along the span direction of the second propeller blade 21 toward the side where the second propeller pressure surface 213 of the second propeller 20 is located. That is, the second propeller blade 21 can start to be anhedral at the position where the distance between the second propeller blade 21 and the center of the second propeller hub 22 is 54.8625 mm. When the plurality of second propeller blades 21 operate at the same time, each of the second propeller leading edge 215 can regularly extend from the second propeller recurve 2122 along the span direction of the second propeller blade 21 toward the side where the second propeller pressure surface 213 of the second propeller 20 is located. As such, the turbulence and downwash airflow generated by the interactions of the plurality of second propeller blades 21 can be reduced, and the turbulence and downwash airflow impacting the housing of the aircraft 1000 can be reduced. Furthermore, a lift point of the second propeller blade 21 can be rated, such that the aircraft 1000 can automatically correct the flight attitude, increase the inertial stability of the aircraft 1000, thereby causing the aircraft 1000 to fly more smoothly. The noise generated by the impact of turbulence and downwash airflow on the housing of the aircraft 1000 can be further reduced.

Since the structure of the second propeller 20 and the structure of the first propeller 10 are mirror-symmetrical to each other, the parameters of the second propeller 20, e.g., the diameter, the second propeller AOA, the second propeller chord length, and the like, can be consistent with those of the first propeller 10.

For example, at D1 where the distance from the center of the second propeller hub 22 equals to 22.6% of the radius of the second propeller 20, the second propeller AOA α2 of the second propeller blade 21 is 27.69°±2.5°, and the second chord length L1 of the second propeller blade 21 is 18.64 mm±5 mm. The air resistance of the second propeller 20 can be further reduced, the pulling force and efficiency can be improved, and the noise can be reduced. The second propeller AOA α1 of the second propeller blade 21 can be 25.19°, 27.69°, or 30.19°, or any one of or any value between two of 25.69°, 26.19°, 26.69°, 27.19°, 28.19°, 28.69°, 29.19°, 29.69°, and the like. The second chord length L1 of the second propeller blade 21 can be 13.64 mm, 18.64 mm, or 23.64 mm, or any one of or any value between two of 14.64 mm, 15.64 mm, 16.64 mm, 17.64 mm, 19.64 mm, 20.64 mm, 21.64 mm, 22.64 mm, and the like.

In some embodiments, at D2 where the distance from the center of the second propeller hub 22 equals to 30.1% of the radius of the second propeller 20, a second propeller AOA α2 of the second propeller blade 21 is 27.51°±2.5°, and a second chord length L2 of the second propeller blade 21 is 19.23 mm±5 mm. The air resistance of the second propeller 10 can be further reduced, the pulling force and efficiency can be improved, and the noise can be reduced. The second propeller AOA α2 of the second propeller blade 21 can be 25.01°, 27.51°, or 30.01°, or any one of or any value between two of 25.51°, 26.01°, 26.51°, 27.01°, 28.01°, 28.51°, 29.01°, 29.51°, and the like. The second chord length L2 of the second propeller blade 21 can be 14.23 mm, 19.23 mm, or 24.23 mm, or any one of or any value between two of 15.23 mm, 16.23 mm, 17.23 mm, 18.23 mm, 20.23 mm, 21.23 mm, 22.23 mm, 23.23 mm, and the like.

In some embodiments, at D3 where the distance from the center of the second propeller hub 22 equals to 37.6% of the radius of the second propeller 20, a second propeller AOA α3 of the second propeller blade 21 is 26.61°±2.5°, and a second chord length L3 of the second propeller blade 21 is 19.07 mm±5 mm. The air resistance of the second propeller 10 can be further reduced, the pulling force and efficiency can be improved, and the noise can be reduced. The second propeller AOA α3 of the second propeller blade 11 can be 24.11°, 26.61°, or 29.11°, or any one of or any value between two of 24.61°, 25.11°, 25.61°, 26.11°, 27.11°, 27.61°, 28.11°, 28.61°, and the like. The second chord length L3 of the second propeller blade 21 can be 14.07 mm, 19.07 mm, or 24.07 mm, or any one of or any value between two of 15.07 mm, 16.07 mm, 17.07 mm, 18.07 mm, 20.07 mm, 21.07 mm, 22.07 mm, 23.07 mm, and the like.

In some embodiments, at D4 where the distance from the center of the second propeller hub 22 equals to 45.1% of the radius of the second propeller 20, a second propeller AOA α4 of the second propeller blade 21 is 25.78°±2.5°, and a second chord length L4 of the second propeller blade 21 is 18.80 mm±5 mm. The air resistance of the second propeller 20 can be further reduced, the pulling force and efficiency can be improved, and the noise can be reduced. The second propeller AOA α4 of the second propeller blade 11 can be 23.28°, 25.78°, or 28.28°, or any one of or any value between two of 23.78°, 24.28°, 24.78°, 25.28°, 26.28°, 26.78°, 27.28°, 27.78°, and the like. The second chord length L4 of the second propeller blade 21 can be 13.80 mm, 18.80 mm, or 23.80 mm, or any one of or any value between two of 14.80 mm, 15.80 mm, 16.80 mm, 17.80 mm, 19.80 mm, 20.80 mm, 21.80 mm, 22.80 mm, and the like.

In some embodiments, at D5 where the distance from the center of the second propeller hub 22 equals to 52.6% of the radius of the second propeller 20, a second propeller AOA α5 of the second propeller blade 21 is 24.10°±2.5°, and a second chord length L5 of the second propeller blade 21 is 18.44 mm±5 mm. The air resistance of the second propeller 20 can be further reduced, the pulling force and efficiency can be improved, and the noise can be reduced. The second propeller AOA α5 of the second propeller blade 21 can be 21.60°, 24.10°, or 26.60°, or any one of or any value between two of 21.10°, 22.60°, 23.10°, 23.60°, 24.60°, 25.10°, 25.60°, 26.10°, and the like. The second chord length L5 of the second propeller blade 21 can be 13.44 mm, 18.44 mm, or 23.44 mm, or any one of or any value between two of 14.44 mm, 15.44 mm, 16.44 mm, 17.44 mm, 19.44 mm, 20.44 mm, 21.44 mm, 22.44 mm, and the like.

In some embodiments, at D6 where the distance from the center of the second propeller hub 22 equals to 60.2% of the radius of the second propeller 20, a second propeller AOA α6 of the second propeller blade 21 is 22.63°±2.5°, and a second chord length L6 of the second propeller blade 21 is 18.00 mm±5 mm. The air resistance of the second propeller 20 can be further reduced, the pulling force and efficiency can be improved, and the noise can be reduced. The second propeller AOA α6 of the second propeller blade 21 can be 20.13°, 22.63°, or 25.13°, or any one of or any value between two of 20.63°, 21.13°, 21.63°, 22.13°, 23.13°, 23.63°, 24.13°, 24.63°, and the like. The second chord length L6 of the second propeller blade 21 can be 13.00 mm, 18.00 mm, or 23.00 mm, or any one of or any value between two of 14.00 mm, 15.00 mm, 16.00 mm, 17.00 mm, 19.00 mm, 20.00 mm, 21.00 mm, 22.00 mm, and the like.

In some embodiments, at D7 where the distance from the center of the second propeller hub 22 equals to 67.7% of the radius of the second propeller 20, a second propeller AOA α7 of the second propeller blade 21 is 20.41°±2.5°, and a second chord length L7 of the second propeller blade 21 is 17.49 mm±5 mm. The air resistance of the second propeller 20 can be further reduced, the pulling force and efficiency can be improved, and the noise can be reduced. The second propeller AOA α7 of the second propeller blade 21 can be 17.91°, 20.41°, or 22.91°, or any one of or any value between two of 18.41°, 18.91°, 19.41°, 19.91°, 20.91°, 21.41°, 21.91°, 22.41°, and the like. The second chord length L7 of the second propeller blade 21 can be 12.49 mm, 17.49 mm, or 22.49 mm, or any one of or any value between two of 13.49 mm, 14.49 mm, 15.49 mm, 16.49 mm, 18.49 mm, 19.49 mm, 20.49 mm, 21.49 mm, and the like.

In some embodiments, at D8 where the distance from the center of the second propeller hub 22 equals to 75.2% of the radius of the second propeller 20, a second propeller AOA α8 of the second propeller blade 21 is 19.19°±2.5°, and a second chord length L8 of the second propeller blade 21 is 17.01 mm±5 mm. The air resistance of the second propeller 20 can be further reduced, the pulling force and efficiency can be improved, and the noise can be reduced. The second propeller AOA α8 of the second propeller blade 21 can be 16.69°, 19.19°, or 21.69°, or any one of or any value between two of 17.19°, 17.69°, 18.19°, 18.69°, 19.69°, 20.19°, 20.69°, 21.19°, and the like. The second chord length L8 of the second propeller blade 21 can be 12.01 mm, 17.01 mm, or 22.01 mm, or any one of or any value between two of 13.01 mm, 14.01 mm, 15.01 mm, 16.01 mm, 18.01 mm, 19.01 mm, 20.01 mm, 21.01 mm, and the like.

In some embodiments, at D9 where the distance from the center of the second propeller hub 22 equals to 82.7% of the radius of the second propeller 20, a second propeller AOA α9 of the second propeller blade 21 is 16.80°±2.5°, and a second chord length L9 of the second propeller blade 21 is 15.90 mm±5 mm. The air resistance of the second propeller 20 can be further reduced, the pulling force and efficiency can be improved, and the noise can be reduced. The second propeller AOA α9 of the second propeller blade 21 can be 14.30°, 16.80°, or 19.30°, or any one of or any value between two of 14.80°, 15.30°, 15.80°, 16.30°, 17.30°, 17.80°, 18.30°, 18.80°, and the like. The second chord length L9 of the second propeller blade 21 can be 10.90 mm, 15.90 mm, or 20.90 mm, or any one of or any value between two of 11.90 mm, 12.90 mm, 13.90 mm, 14.90 mm, 16.90 mm, 17.90 mm, 18.90 mm, 19.90 mm, and the like.

In some embodiments, at D10 where the distance from the center of the second propeller hub 22 equals to 90.2% of the radius of the second propeller 20, a second propeller AOA α10 of the second propeller blade 21 is 16.77°±2.5°, and a second chord length L10 of the second propeller blade 21 is 13.04 mm±5 mm. The air resistance of the second propeller 20 can be further reduced, the pulling force and efficiency can be improved, and the noise can be reduced. The second propeller AOA α10 of the second propeller blade 21 can be 14.27°, 16.77°, or 19.27°, or any one of or any value between two of 14.77°, 15.27°, 15.77°, 16.27°, 17.27°, 17.77°, 18.27°, 18.77°, and the like. The second chord length L10 of the second propeller blade 21 can be 8.04 mm, 13.04 mm, or 18.04 mm, or any one of or any value between two of 9.04 mm, 10.04 mm, 11.04 mm, 12.04 mm, 14.04 mm, 15.04 mm, 16.04 mm, 17.04 mm, and the like.

In some embodiments, at D11 where the distance from the center of the second propeller hub 22 equals to 100% of the radius of the second propeller 20, a second propeller AOA all of the second propeller blade 21 is 15.30°±2.5°, and a second chord length L11 of the second propeller blade 21 is 4.15 mm±2 mm. The air resistance of the second propeller 20 can be further reduced, the pulling force and efficiency can be improved, and the noise can be reduced. The second propeller AOA all of the second propeller blade 21 can be 12.80°, 15.30°, or 17.80°, or any one of or any value between two of 13.30°, 13.80°, 14.30°, 14.80°, 15.80°, 16.30°, 16.80°, 17.30°, and the like. The second chord length L11 of the second propeller blade 21 can be 2.15 mm, 4.15 mm, or 6.15 mm, or any one of or any value between two of 2.65 mm, 3.15 mm, 3.65 mm, 4.65 mm, 5.15 mm, 5.65 mm, and the like.

In some embodiments, the diameter of the second propeller 20 is 133 mm±13.3 mm. At D1 15 mm from the center of the second propeller hub 22, the second propeller AOA α1 of the second propeller blade 21 is 27.69°, and the second chord length L1 of the second propeller blade 21 is 18.64 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D2 20 mm from the center of the second propeller hub 22, the second propeller AOA α2 of the second propeller blade 21 is 27.51°, and the second chord length L2 of the second propeller blade 21 is 19.23 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D3 25 mm from the center of the second propeller hub 22, the second propeller AOA α3 of the second propeller blade 21 is 26.61°, and the second chord length L3 of the second propeller blade 21 is 19.07 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D4 30 mm from the center of the second propeller hub 22, the second propeller AOA α4 of the second propeller blade 21 is 25.78°, and the second chord length L4 of the second propeller blade 21 is 18.80 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D5 35 mm from the center of the second propeller hub 22, the second propeller AOA α5 of the second propeller blade 21 is 24.10°, and the second chord length L5 of the second propeller blade 21 is 18.44 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D6 40 mm from the center of the second propeller hub 22, the second propeller AOA α6 of the second propeller blade 21 is 22.63°, and the second chord length L6 of the second propeller blade 21 is 18.00 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D7 45 mm from the center of the second propeller hub 22, the second propeller AOA α7 of the second propeller blade 21 is 20.41°, and the second chord length L7 of the second propeller blade 21 is 17.49 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 10 is 133 mm±13.3 mm. At D8 50 mm from the center of the second propeller hub 22, the second propeller AOA α8 of the second propeller blade 21 is 19.19°, and the second chord length L8 of the second propeller blade 21 is 17.01 mm. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D9 55 mm from the center of the second propeller hub 22, the second propeller AOA α9 of the second propeller blade 21 is 16.80°, and the second chord length L9 of the second propeller blade 21 is 15.90 mm. The air resistance of the second propeller 20 can be further reduced, the pulling force and efficiency can be improved, and the noise can be reduced. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D10 60 mm from the center of the second propeller hub 22, the second propeller AOA α10 of the second propeller blade 21 is 16.77°, and the second chord length L10 of the second propeller blade 21 is 13.04 mm. The air resistance of the second propeller 20 can be further reduced, the pulling force and efficiency can be improved, and the noise can be reduced. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

In some embodiments, the diameter of the second propeller 20 is 133 mm±13.3 mm. At D11 66.5 mm from the center of the second propeller hub 22, the second propeller AOA all of the second propeller blade 21 is 15.30°, and the second chord length L11 of the second propeller blade 21 is 4.15 mm. The air resistance of the second propeller 20 can be further reduced, the pulling force and efficiency can be improved, and the noise can be reduced. The diameter of the second propeller 20 can be 119.7 mm, 133 mm, or 146.3 mm, or any one of or any value between two of 123 mm, 126.3 mm, 129.6 mm, 132.9 mm, 136.2 mm, 139.5 mm, 142.8 mm, 146.1 mm, and the like.

Referring again to FIGS. 7 to 25, in some embodiments, both a pitch of the first blade 11 and a pitch of the second blade 21 can be 3.5±0.5 inches. Therefore, the air resistance can be reduced, and the pulling forces of the first blade 11 and the second blade 21 can be improved. The pitch of the first blade 11 may be 3.0 inches, 3.5 inches, or 4.0 inches, or any one of or any value between two of 3.1 inches, 3.2 inches, 3.3 inches, 3.4 inches, 3.6 inches, 3.7 inches, 3.8 inches, 3.9 inches, and the like.

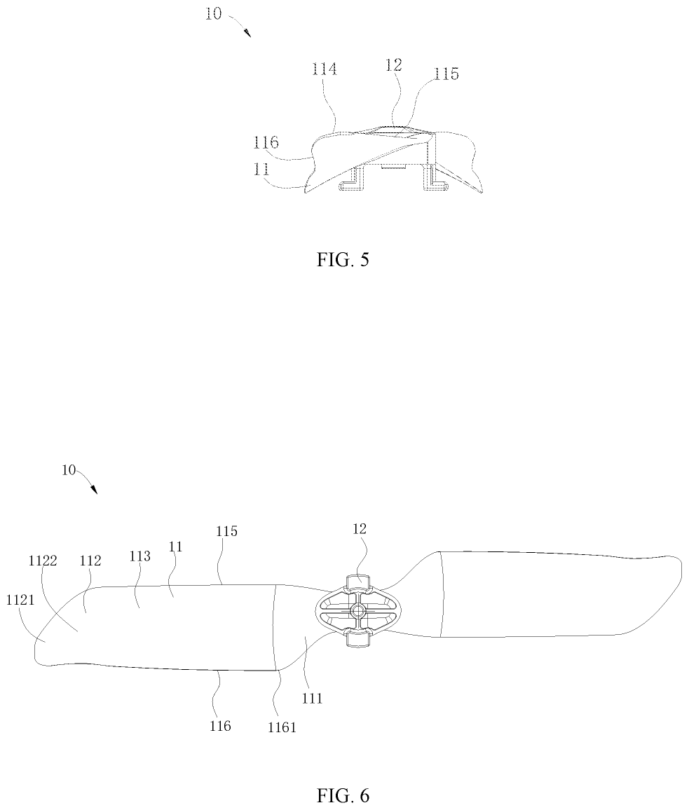

Table. 5 compares test results of the first propeller 10 or the second propeller 20 in the propeller assembly 100 consistent with the disclosure with the existing propeller. As shown in FIG. 5, under the same pulling force, the first propeller 10 or the second propeller 20 consistent with the disclosure can have lower power. That is, under lower power conditions, the first propeller 10 or the second propeller 20 can have greater pulling force, thereby reducing a power consumption and increasing the flight distance of the aircraft 1000. Therefore, the propeller assembly 100 consistent with the disclosure can significantly increase the pulling force, ensure a sufficient power, extend a flight time, and improve the flight performance of the aircraft 1000 in extreme situations, for example, in high altitude areas having a low density or in low altitude areas with a large take-off weight.

TABLE 5

| Existing propeller | | | First propeller 10 or second propeller 20 | | |
|---|---|---|---|---|---|
| Pulling | Rotation | | Pulling | Rotation | |
| force | speed | Power | force | speed | Power |
| (g) | (RPM) | (W) | (g) | (RPM) | (W) |
| 80 | 8750 | 6.5 | 80 | 6700 | 6.1 |
| 120 | 10700 | 11.7 | 120 | 8400 | 10.7 |
| 160 | 12700 | 18.2 | 160 | 9800 | 16.3 |

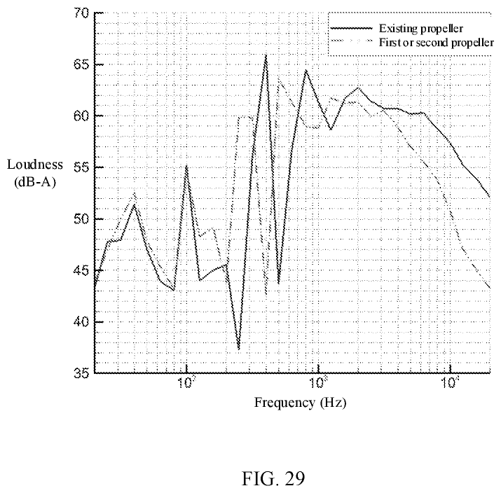

FIG. 29 is a schematic frequency response curve of the first propeller 10 or the second propeller 20 of the propeller assembly 100 consistent with the disclosure and the existing propeller under a same acoustic performance test conditions of hovering. Table. 6 compares the test results of the first propeller 10 or the second propeller 20 in the propeller assembly 100 consistent with the disclosure with the existing propeller. As shown in Table. 6, under the same acoustic performance test conditions of hovering, the noise generated by the first propeller 10 or the second propeller 20 of the propeller assembly 100 consistent with the disclosure is compared with noise generated by the existing propeller. The overall noise of the first propeller 10 or the second propeller 20 of the propeller assembly 100 is lower than that of the existing propeller. From the frequency response curve, e.g., Frequency (Hz)-Loudness (dB-A) shown in FIG. 29, it can be seen that under most of the same higher frequency conditions, a loudness of the first propeller 10 or the second propeller 20 consistent with the disclosure is lower than that of existing propeller. As such, the propeller assembly 100 consistent with the disclosure can reduce high-frequency noise, reduce a discomfort of the human ear caused by the high-frequency noise, and improve a user experience. Furthermore, the propeller assembly 100 consistent with the disclosure can be used in scenes with high requirements for sound, such as reconnaissance, aerial photography (video and audio are recorded during aerial photography), and the like.

TABLE 6

| Acoustic performance | | loudness | | Full band |
|---|---|---|---|---|
| test conditions of | Loudness | level | Sharpness | loudness |
| hovering | (sone) | (phon) | (acum) | (dB) |
| Existing propeller | 31.65 | 89.84 | 4.39 | 73.93 |
| First propeller 10 or | 26.22 | 87.13 | 3.65 | 70.33 |
| second propeller 20 of | | | | |
| propeller assembly 100 | | | | |

Therefore, the first propeller 10 and the second propeller 20 of the propeller assembly 100 consistent with the disclosure can reduce the air resistance, improve the pulling force and the efficiency, increase the flight distance of the aircraft 1000, and improve the flight performance of the aircraft 1000. Compared with the existing propeller on the market, under the same acoustic performance test conditions of hovering, the overall noise generated by the propeller assembly 100 using the first propeller 10 and the second propeller 20 can be lower than the existing propeller assembly. Therefore, the propeller assembly 100 consistent with the disclosure can effectively reduce the noise power. Moreover, under most of the same higher frequency conditions, the loudness of the propeller assembly 100 using the first propeller 10 and the second propeller 20 consistent with the disclosure can be lower than that of the existing propeller assembly. As such, the propeller assembly 100 consistent with the disclosure can reduce the high-frequency noise, reduce the discomfort of the human ear caused by the high-frequency noise, and improve the user experience. Therefore, the propeller assembly 100 consistent with the disclosure can reduce the noise power.

Referring again to FIG. 1, the present disclosure further provides a power assembly 200 including a first driving device 30, a second driving device 40, and the propeller assembly 100 described above. The first propeller 10 is connected to the first driving device 30 via the first propeller hub 12 of the first propeller 10, and the second propeller 20 is connected to the second driving device 40 via the second propeller hub 22 of the second propeller 20. The power assembly 200 includes at least two arms 50. The at least two arms 50 can be connected at a center of the propeller assembly 100. The first driving device 30 and the second driving device 40 can be arranged at the at least two arms 50. The detailed description of the structure of the propeller assembly 100 will be omitted herein. The propeller assembly 100 described above can be applicable to the power assembly 200 consistent with the disclosure.

Referring again to FIGS. 2, 3, 21, and 22, in the power assembly 200, the first propeller tip 112 of the propeller assembly 100 can be configured to extend obliquely along the span direction of the first propeller blade 11 toward the side where the first propeller suction surface 114 is located. The second propeller tip 212 can be configured to extend obliquely along the span direction of the second propeller blade 21 toward the side where the second propeller suction surface 214 is located. The propeller assembly 100 using the first propeller blade 11 and the second propeller blade 21 can reduce the air resistance and improve the tension and efficiency. The flight distance of the aircraft 1000 can be increased, the flight performance of the aircraft 1000 can be improved, and the noise generated by the first propeller blade 11 and the second propeller blade 21 during operation can be reduced, thereby causing the aircraft 1000 to be quieter when hovering and improving the user experience.

In some embodiments, both the first driving device 30 and the second driving device 40 can include motors, and a kilovolt (KV) value of the motors can be 2700 to 4324 revolutions/(minute·volt). Thus, the power performance of the power assembly 200 can be ensured.

FIG. 30 is a schematic plan view of the aircraft 1000 consistent with the disclosure. As shown in FIG. 30, the aircraft 1000 includes a body 60 and the power assembly 200 described above, and the power assembly 200 can be connected to the body 60. The plurality of arms 50 of the power assembly 200 can be connected to the body 60 to mount the power assembly 200 at the body 60. The detailed description of the structure of the power assembly 200 will be omitted herein. That is, the power assembly 200 described above can be applicable to the aircraft 1000 consistent with the disclosure.

In some embodiments, the aircraft 1000 can include a multi-rotor aircraft, such as a four-rotor unmanned aircraft.

Referring again to FIGS. 2, 3, 21, and 22, in the aircraft 1000, the first propeller tip 112 of the propeller assembly 100 can be configured to extend obliquely along the span direction of the first propeller blade 11 toward the side where the first propeller suction surface 114 is located. The second propeller tip 212 can be configured to extend obliquely along the span direction of the second propeller blade 21 toward the side where the second propeller suction surface 214 is located. The propeller assembly 100 using the first propeller blade 11 and the second propeller blade 21 can reduce the air resistance and improve the tension and efficiency. The flight distance of the aircraft 1000 can be increased, the flight performance of the aircraft 1000 can be improved, and the noise generated by the first propeller blade 11 and the second propeller blade 21 during operation can be reduced, thereby causing the aircraft 1000 to be quieter when hovering and improving the user experience.

It is intended that the specification and examples be considered as exemplary only and not to limit the scope of the disclosure, with a true scope and spirit of the invention being indicated by the following claims. Other embodiments of the disclosure will be apparent to those skilled in the art from consideration of the specification and practice of the embodiments disclosed herein. Changes, modifications, alterations, and variations of the above-described embodiments may be made by those skilled in the art within the scope of the disclosure.

What is claimed is:

1. A propeller assembly comprising:
a first propeller including a first propeller blade including:
a first propeller root;
a first propeller tip opposite to the first propeller root;
a first propeller pressure surface; and
a first propeller suction surface opposite to the first propeller pressure surface; and
a second propeller including a second propeller blade including:
a second propeller root;
a second propeller tip opposite to the second propeller root;
a second propeller pressure surface; and
a second propeller suction surface opposite to the second propeller pressure surface;
wherein:
the first propeller tip is configured to extend obliquely along a span direction of the first propeller blade toward a side where the first propeller suction surface is located; and
the second propeller tip is configured to extend obliquely along a span direction of the second propeller blade toward a side where the second propeller pressure surface is located.

2. The propeller assembly of claim 1, wherein the first propeller blade further includes:
a propeller leading edge connecting one edge of the first propeller pressure surface and one edge of the first propeller suction surface;
a propeller trailing edge connecting another edge of the first propeller pressure surface and another edge of the first propeller suction surface; and
a propeller backward-sweeping portion formed at the first propeller tip and configured to extend obliquely from the propeller leading edge to the propeller trailing edge.

3. The propeller assembly of claim 2, wherein:
the first propeller blade includes a propeller recurve at a position of the first propeller tip; and
the propeller leading edge is configured to extend obliquely from the propeller recurve along the span direction of the first propeller blade toward the side where the first propeller suction surface is located.

4. The propeller assembly of claim 3, wherein:
the first propeller further includes a propeller hub; and
a distance from the propeller recurve to a center of the propeller hub equals 82.5% of a radius of the first propeller.

5. The propeller assembly of claim 2, wherein the propeller trailing edge is convex to form a curved propeller arching portion proximal to the first propeller root.

6. The propeller assembly of claim 2, wherein:
the first propeller further includes a propeller hub; and
the first propeller blade is one of at least two first propeller blades of the first propeller, the at least two first propeller blades being connected to the propeller hub and centrosymmetric to each other about a center of the propeller hub.

7. The propeller assembly of claim 6, wherein:
the first propeller blade has a propeller center axis passing through the center of the propeller hub;
the propeller leading edge has a propeller leading edge tangent line parallel to the propeller center axis;
the propeller trailing edge has a propeller trailing edge tangent line parallel to the propeller center axis; and
the propeller backward-sweeping portion is located between the propeller leading edge tangent line and the propeller trailing edge tangent line.

8. The propeller assembly of claim 1, wherein the first propeller suction surface and the first propeller pressure surface are curved surfaces.

9. The propeller assembly of claim 1, wherein the first propeller and the second propeller are two of two or more propellers of the propeller assembly, and are neighboring to each other.

10. The propeller assembly of claim 1, wherein:
the first propeller is one of two first propellers of the propeller assembly;
the second propeller is one of two second propellers of the propeller assembly; and
each of the two first propellers is arranged neighboring to the two second propellers.

11. The propeller assembly of claim 1, wherein at a distance to a center of a propeller hub of the first propeller equaling 45.1% of a radius of the first propeller, a propeller angle of attack (AOA) of the first propeller blade is 25.78°±2.5°, and a chord length of the first propeller blade is 18.80 mm±5 mm.

12. The propeller assembly of claim 11, wherein:
a diameter of the first propeller is 133 mm±13.3 mm; and
at a position 30 mm from the center of the propeller hub, the propeller AOA of the first propeller blade is 25.78°, and the chord length of the first propeller blade is 18.80 mm.

13. The propeller assembly of claim 1, wherein at a distance to a center of a propeller hub of the first propeller equaling 52.6% of a radius of the first propeller, a propeller AOA of the first propeller blade is 24.10°±2.5°, and a chord length of the first propeller blade is 18.44 mm±5 mm.

14. The propeller assembly of claim 13, wherein:
a diameter of the first propeller is 133 mm±13.3 mm; and
at a position 35 mm from the center of the propeller hub, the propeller AOA of the first propeller blade is 24.10°, and the chord length of the first propeller blade is 18.44 mm.

15. The propeller assembly of claim 1, wherein at a distance to a center of a propeller hub of the first propeller equaling 60.2% of a radius of the first propeller, a propeller AOA of the first propeller blade is 22.63°±2.5°, and a chord length of the first propeller blade is 18.00 mm±5 mm.

16. The propeller assembly of claim 15, wherein:
a diameter of the first propeller is 133 mm±13.3 mm; and
at a position 40 mm from the center of the propeller hub, the propeller AOA of the first propeller blade is 22.63°, and the chord length of the first propeller blade is 18.00 mm.

17. The propeller assembly of claim 1, wherein at a distance to a center of a propeller hub of the first propeller equaling 67.7% of a radius of the first propeller, a propeller AOA of the first propeller blade is 20.41°±2.5°, and a chord length of the first propeller blade is 17.49 mm±5 mm.

18. The propeller assembly of claim 17, wherein:
a diameter of the first propeller is 133 mm±13.3 mm; and
at a position 45 mm from the center of the propeller hub, the propeller AOA of the first propeller blade is 20.41°, and the chord length of the first propeller blade is 17.49 mm.

19. A power assembly comprising:
a first driving device;
a second driving device; and
a propeller assembly including:
a first propeller connected to the first driving device and including a first propeller blade including:
a first propeller root;
a first propeller tip opposite to the first propeller root;
a first propeller pressure surface; and
a first propeller suction surface opposite to the first propeller pressure surface; and
a second propeller connected to the second driving device and including a second propeller blade including:
a second propeller root;
a second propeller tip opposite to the second propeller root;
a second propeller pressure surface; and
a second propeller suction surface opposite to the second propeller pressure surface;
wherein:
the first propeller tip is configured to extend obliquely along a span direction of the first propeller blade toward a side where the first propeller suction surface is located; and
the second propeller tip is configured to extend obliquely along a span direction of the second propeller blade toward a side where the second propeller pressure surface is located.

20. An aircraft comprising:
a body; and
a power assembly connected to the body and including:
a first driving device;
a second driving device; and
a propeller assembly including:
a first propeller connected to the first driving device and including a first propeller blade including:
a first propeller root;
a first propeller tip opposite to the first propeller root;
a first propeller pressure surface; and
a first propeller suction surface opposite to the first propeller pressure surface; and
a second propeller connected to the second driving device and including a second propeller blade including:
a second propeller root;
a second propeller tip opposite to the second propeller root;
a second propeller pressure surface; and
a second propeller suction surface opposite to the second propeller pressure surface;
wherein:
the first propeller tip is configured to extend obliquely along a span direction of the first propeller blade toward a side where the first propeller suction surface is located; and
the second propeller tip is configured to extend obliquely along a span direction of the second propeller blade toward a side where the second propeller pressure surface is located.
